(19) United States
(12) Patent Application Publication
(10) Pub. No.: US 2009/0100529 A1
(43) Pub. Date: Apr. 16, 2009

(54) DEVICE, SYSTEM, AND METHOD OF FILE-UTILIZATION MANAGEMENT

(76) Inventors: Noam Livnat, Tel Aviv (IL); Michael Boodaei, Givatayim (IL)

Correspondence Address: EMPK & Shiloh, LLP;c/o Landon IP, Inc., 1700 Diagonal Road, Suite 450, Alexandria, VA, 22314, US

(21) Appl. No.: 12/249,934

(22) Filed: Oct. 12, 2008

Related U.S. Application Data
(60) Provisional application No. 60/979,125, filed on Oct. 11, 2007.

(51) Int. Cl. H04L 9/32

(52) U.S. Cl. 726/28

(57) ABSTRACT

Device, system, and method of file-utilization management. In some embodiments, a method may include linking between a computing device and at least one electronic mail address by verifying that a user of the linked computing device is authorized to access an electronic mail account represented by the linked electronic mail address; identifying an attempt by the user to access the content of a protected file, wherein the protected file is associated with permission information representing one or more allowed electronic mail addresses and including one or more content-utilization restrictions; and presenting the content of the protected file to the user of the linked device, if the linked electronic mail address is included in the allowed electronic mail addresses, while restricting the utilizing of the presented content according to a content-utilization restriction corresponding to the linked electronic mail address. Other embodiments are described and claimed.

### CROSS-REFERENCE

This application claims priority from and the benefit of U.S. Provisional Patent application 60/979,125, entitled “A File-level Protection System, Method, and Computer Readable Code”, filed Oct. 11, 2007, the entire disclosure of which is incorporated herein by reference.

### FIELD

Some embodiments relate generally to the field of protecting and/or securing information and, more particularly, to file-utilization management, e.g., according to an Enterprise-Digital-Rights-Management (EDRM) scheme.

### BACKGROUND

Enterprise Digital Rights Management (EDRM) systems may be capable of securing and/or protecting electronic organizational files, for example, such that only authorized users are allowed to access the files only according to predefined permissions and/or restrictions. For example, a document owner may provide a first user with permission to view the content of the document, while not allowing the first user to copy, print and/or save the content. The document owner may provide a second user with permission to view and print the content of the document, and so on.

The EDRM systems may allow secure information sharing, by enabling the users to selectively share files with clients, partners and/or suppliers, while prohibiting the sharing of the content with unauthorized people.

Some conventional EDRM systems may require a relatively complex initial sign-up procedure, which may have relatively strong authentication requirements. As a result, such EDRM systems may have limited support or may not be able to support inter-company communication of documents between users of different enterprises and/or companies.

Some of the conventional EDRM systems may require the installation of special client software on each user's computer. Such requirement may be problematic for an organization, which restricts and/or prohibits the installation of client software, and/or if the organization uses software and/or hardware platforms not supported by a vendor of the EDRM system.

Additionally, some EDRM systems may require significant training and know-how from the users.

### SUMMARY

Some embodiments include, for example, devices, systems, and methods of file-utilization management, e.g., according to an Enterprise-Digital-Rights-Management (EDRM) scheme.

Some embodiments may be implemented to provide an EDRM system having a simplified sign-up process, a simplified file-protection process, a simplified process for accessing a protected file, and/or a simplified process for managing and/or updating utilization restrictions of the protected file, e.g., via a client application service, and/or via a web application service.

In some embodiments, the EDRM system may be adapted to provide one or more users with EDRM capabilities using online web access, e.g., to enforce EDRM protections on files without the need to install client software on the user's computing device. In some embodiments, such online web access may be implemented to allow users of different organizations to share files, while enforcing the EDRM protections.

Some embodiments may allow a user (“the file owner”) to define one or more permissions identifying who can and/or who cannot gain access to one or more files “owned” by the user; and/or to define one or more utilization-restrictions to be selectively applied on one or more of the users which are allowed to access the owned file (“the allowed users”). For example, the file owner may define that a first allowed user may not be permitted to perform one or more of copy-pasting the content of the owned file, performing a print screen operation of an image representing the content of the owned file, printing the file, editing the file, and/or any other form of utilizing the owned file, while a second allowed user may be permitted to perform one or more of these operations.

In some embodiments, additionally or alternatively, the file owner may be provided with the capability of tracking substantially all digital copies of the file and/or receiving information regarding access of other users to the owned file, such as, who opened the file and when, who printed the file and when, who edited the file and when, and the like.

In some embodiments, additionally or alternatively, the file owner may be provided with the capability of remotely accessing substantially all digital copies of the file, in order, for example, to update the permissions and/or restrictions, e.g., including complete access revocation.

In some embodiments, a method of file-utilization management may include linking between a computing device and at least one electronic mail address by verifying that a user of the linked computing device is authorized to access an electronic mail account represented by the linked electronic mail address; identifying an attempt by the user to access the content of a protected file, wherein the protected file is associated with permission information representing one or more allowed electronic mail addresses and including one or more content-utilization restrictions; and presenting the content of the protected file to the user of the linked device, if the linked electronic mail address is included in the allowed electronic mail addresses, while restricting the utilizing of the presented content according to a content-utilization restriction corresponding to the linked electronic mail address. In some embodiments, the presenting may include presenting the content to the user, only if the attempt to access the content of the protected file is performed using the linked computing device.

In some embodiments, linking between the electronic mail address and the computing device may include storing a tag identifying the linked device in association with the linked electronic mail address.

In some embodiments, linking between the electronic mail address and the device may include providing the linked device with a cookie message including the tag.

In some embodiments, linking between the electronic mail address and the computing device may include associating the linked electronic mail address and an identifier of a client application executed by the computing device.

In some embodiments, verifying that the user is authorized to access the electronic mail account may include informing a server of the electronic mail address; and receiving a verification notification from the server, if the user is authorized to access the electronic mail account.

In some embodiments, the method may include automatically detecting an electronic mail message from the server at the electronic mail account, wherein the message includes authentication information; and automatically sending to the server a response based on the authentication information.

In some embodiments, verifying that the user is authorized to access the electronic mail account may include sending to the electronic mail address an electronic mail message including first authentication information; and verifying that the user is authorized to access the electronic mail account based on a received response including second authentication information.

In some embodiments, verifying the electronic mail address based on the response may include at least one of determining whether the second authentication information matches the first authentication information; determining whether the response was received more than a predefined time period after the electronic mail message was sent; determining whether a previously received response included the first authentication information; determining whether the response was sent by the device; and determining whether the response was sent from one or more predefined Internet-protocol addresses.

In some embodiments, the method may include generating the protected file by receiving the content and the permission information; and generating a web-application file including the content in a format presentable by a secure web application capable of managing the utilization of the content according to the content-utilization restrictions; wherein presenting the content of the protected file may include presenting the web-application file via the secure web application.

In some embodiments, the method may include storing the web-application file; storing the identifier of the web-application file in association with the permission information corresponding to the web-application file; and generating a link including an identifier of the web-application file; wherein identifying the attempt to access the content of the protected file includes receiving the link, and identifying the web-application file based on the identifier.

In some embodiments, the content of the protected file is encrypted using at least a public key associated with the linked electronic mail address, wherein presenting the content of the protected file includes decrypting the content using a private key corresponding to the public key.

In some embodiments, the method may include protecting a requested file based on user-defined permission information identifying one or more requested electronic mail addresses and including one or more utilization restrictions corresponding to the requested electronic mail addresses. Protecting the requested file may include encrypting the requested file using an encryption key to generate an encrypted file; generating one or more encrypted keys corresponding to the one or more requested electronic mail addresses, respectively, by encrypting the encryption key using one or more predefined keys associated with the requested electronic mail addresses; and generating a requested protected file including the encrypted file, the encrypted keys, and the permission information.

In some embodiments, the predefined keys include at least one of a public key associated with a requested electronic mail address, a domain key associated with an Internet domain, and a general key associated with all verified electronic mail addresses.

In some embodiments, the method may include updating the permission information of the protected file, wherein presenting the content of the protected file may include presenting the content to the user, only if the linked electronic mail address is included in the allowed electronic mail addresses identified by the updated permission information, and wherein restricting the utilizing of the presented content may include restricting the utilizing of the presented content according to a content-utilization restriction included in the updated permission information.

In some embodiments, the permission information identifying the allowed electronic mail addresses includes at least one Internet domain, wherein presenting the content of the protected file includes presenting the content of the protected file to the user if the linked electronic mail address belongs to the domain.

In some embodiments, the content of the protected file is encrypted using at least a public domain key associated with the domain, wherein presenting the content of the protected file includes decrypting the content using a private domain key corresponding to the public domain key.

In some embodiments, the permission information identifying the allowed electronic mail addresses indicates that the allowed electronic mail addresses include all verified electronic mail addresses.

In some embodiments, the content of the protected file is encrypted using at least a general public key, wherein presenting the content of the protected file includes decrypting the content using a generic private key corresponding to the general public key.

Some embodiments include a computing device including a client application to link between a computing device and at least one electronic mail address by verifying that a user of the linked computing device is authorized to access an electronic mail account represented by the linked electronic mail address; identify an attempt by the user to access the content of a protected file, wherein the protected file is associated with permission information representing one or more allowed electronic mail addresses and including one or more content-utilization restrictions; and present the content of the protected file to the user of the linked device, if the linked electronic mail address is included in the allowed electronic mail addresses, while restricting the utilizing of the presented content according to a content-utilization restriction corresponding to the linked electronic mail address.

In some embodiments, the client application is to link between the electronic mail address and the computing device by storing the linked electronic mail address.

In some embodiments, the client application is to verify that the user is authorized to access the electronic mail account by informing a server of the electronic mail address; and receiving a verification notification from the server, if the user is authorized to access the electronic mail account.

In some embodiments, the client application is to automatically detect an electronic mail message from the server at the electronic mail account, wherein the message includes authentication information; and to automatically send to the server a response based on the authentication information.

In some embodiments, the client application is to protect a requested file based on user-defined permission information identifying one or more requested electronic mail addresses and including one or more utilization restrictions corresponding to the requested electronic mail addresses. The client application is to protect the requested file by encrypting the requested file using an encryption key to generate an encrypted file; generating one or more encrypted keys corresponding to the one or more requested electronic mail addresses, respectively, by encrypting the encryption key using one or more predefined keys associated with the requested electronic mail addresses; and generating a requested protected file including the encrypted file, the encrypted keys, and the permission information.

In some embodiments, the predefined keys include at least one of a public key associated with a requested electronic mail address, a domain key associated with an Internet domain, and a general key associated with all verified electronic mail addresses.

In some embodiments, the client application is to receive updated permission information corresponding to the file, wherein the client application is to present the content to the user, only if the linked electronic mail address is included in the allowed electronic mail addresses identified by the updated permission information, and to restrict the utilizing of the presented content according to a content-utilization restriction included in the updated permission information.

In some embodiments, the permission information identifying the allowed electronic mail addresses includes at least one Internet domain, wherein the client application is to present the content of the protected file to the user if the linked electronic mail address belongs to the domain.

In some embodiments, the content of the protected file is encrypted using at least a public domain key associated with the domain, wherein the client application is to decrypt the content using a private domain key corresponding to the public domain key.

In some embodiments, the permission information identifying the allowed electronic mail addresses indicates that the allowed electronic mail addresses include all verified electronic mail addresses.

In some embodiments, the content of the protected file is encrypted using at least a general public key, wherein the client application is to decrypt the content using a generic private key corresponding to the general public key.

Some embodiments include an EDRM system including a server to link between a computing device and at least one electronic mail address by verifying that a user of the linked computing device is authorized to access an electronic mail account represented by the linked electronic mail address; to identify an attempt by the user to access the content of a protected file, wherein the protected file is associated with permission information representing one or more allowed electronic mail addresses and including one or more content-utilization restrictions; and to present the content of the protected file to the user of the linked device, if the linked electronic mail address is included in the allowed electronic mail addresses, while restricting the utilizing of the presented content according to a content-utilization restriction corresponding to the linked electronic mail address.

In some embodiments, the server is to present the content to the user, only if the attempt to access the content of the protected file is performed using the linked computing device.

In some embodiments, the server is to store a tag identifying the linked device in association with the linked electronic mail address.

In some embodiments, the server is to provide the linked device with a cookie message including the tag.

In some embodiments, the server is to send to the electronic mail address an electronic mail message including first authentication information; and verify that the user is authorized to access the electronic mail account based on a received response including second authentication information.

In some embodiments, the server is to verify the electronic mail address based on the response by performing at least one of determining whether the second authentication information matches the first authentication information; determining whether the response was received more than a predefined time period after the electronic mail message was sent; determining whether a previously received response included the first authentication information; determining whether the response was sent by the device; and determining whether the response was sent from one or more predefined Internet-protocol addresses.

In some embodiments, the server is to generate the protected file by receiving the content and the permission information; and generating a web-application file including the content in a format presentable by a secure web application capable of managing the utilization of the content according to the content-utilization restrictions, wherein the server is to present the content of the protected file by presenting the web-application file via the secure web application.

In some embodiments, the server is to store the web-application file; store the identifier of the web-application file in association with the permission information corresponding to the web-application file; generate a link including an identifier of the web-application file; receive the link; and identify the web-application file based on the identifier of the link.

In some embodiments, the server is to protect a requested file based on user-defined permission information identifying one or more requested electronic mail addresses and including one or more utilization restrictions corresponding to the requested electronic mail addresses. The server may protect the requested file by encrypting the requested file using an encryption key to generate an encrypted file; generating one or more encrypted keys corresponding to the one or more requested electronic mail addresses, respectively, by encrypting the encryption key using one or more predefined keys associated with the requested electronic mail addresses; and generating a requested protected file including the encrypted file, the encrypted keys, and the permission information.

In some embodiments, the predefined keys include at least one of a public key associated with a requested electronic mail address, a domain key associated with an Internet domain, and a general key associated with all verified electronic mail addresses.

Some embodiments may provide other and/or additional benefits and/or advantages including, but not limited to, trade term sheet, trade agreement, trade summary, trade confirmations, trade reporting, trade reconciliations, trade settlements, help and training documents, and the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic flow-chart illustration of a method of file-utilization management in accordance with some demonstrative embodiments.

FIG. 3 is a schematic flow-chart illustration of a method of linking between a computing device and an email address, in accordance with one demonstrative embodiment.

FIG. 4 is a schematic flow-chart illustration of a method of linking between a computing device and an email address, in accordance with another demonstrative embodiment.

FIG. 5 is a schematic flow-chart illustration of a method of protecting a file, in accordance with some demonstrative embodiments.

FIG. 6 is a schematic flow-chart illustration of a method of updating permission information corresponding to a protected file, in accordance with some demonstrative embodiments.

FIG. 7 is a schematic flow-chart illustration of a method of managing the utilization of a protected file, in accordance with one demonstrative embodiment.

FIG. 8 is a schematic flow-chart illustration of a method of managing the utilization of a protected file, in accordance with another demonstrative embodiment.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

The terms “file” and document, as interchangeably used herein, relate to any suitable electronic file, document, article, and/or record, e.g., a data file, a text file, a media file, and the like. For example, a file may include a set of related information that a computer can access by a unique name. The file may be stored by any suitable computer-readable medium, for example, an electronic, magnetic, optical, electromagnetic, infrared, or semiconductor medium, e.g., a semiconductor or solid state memory, magnetic tape, a removable computer diskette, a random access memory, a rigid magnetic disk, an optical disk, a compact disk, a disk on key, and the like.

The term “content” as used herein includes any suitable data, information, and the like.

The term “presenting” as used herein with relation to content may include displaying, outputting, exposing, disclosing and/or providing the content in any suitable manner.

The term “utilizing” as used herein with relation to content may include editing, printing, exporting, copying, displaying, and/or sending at least part of the content; printing, storing and/or exporting a representation of at least part of the content, e.g., using a “print-screen” command; saving and/or storing at least part of the content in retrievable manner; and/or any other operation allowing future use of at least part of the content.

Some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee (TM), Global System for Mobile communication (GSM), 2G, 2.5G, 3G, 3.5G, or the like. Some embodiments may be used in various other devices, systems and/or networks.

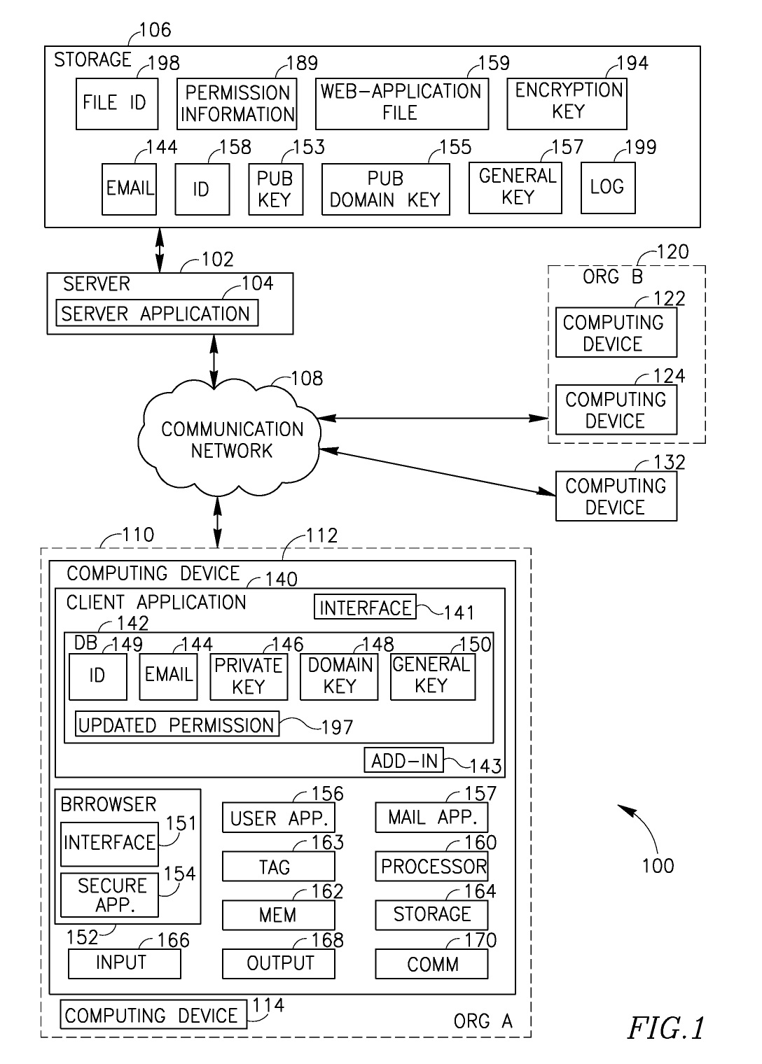

Reference is now made to FIG. 1, which schematically illustrates a block diagram of a system 100 in accordance with some demonstrative embodiments.

In some embodiments, system 100 may perform the functionality of an Enterprise-Digital-Rights-Management (EDRM) system.

In some embodiments, system 100 may implement a Software as a Service (SaaS) architecture capable of providing web-based EDRM services to one or more users and/or enterprises. In other embodiments, system 100 may implement any other suitable architecture and/or provide any other suitable online and/or offline services.

System 100 may include one or more computing devices capable of communicating with at least one server 102, e.g., via a communication network 108. Communication network 108 may include any suitable communication network, for example, an Ethernet communication network, the Internet and/or any combination thereof, and the like.

In some embodiments, system 100 may include devices operated by different enterprises, organizations, companies, owners, entities, and the like. For example, system 100 may include one or more computing devices, e.g., computing devices 112 and 114, operated by users of a first organization (“ORG A”); one or more computing devices, e.g., computing devices 122 and 124, operated by users of a second organization (“ORG B”); and/or one or more computing devices, e.g., computing devices 132, operated by one or more other entities, e.g., private or non-corporate users.

In some embodiments, computing devices 112, 114, 122, 124 and/or 132 may include a processor 160, a memory 162, a storage unit 164, an input unit 166, an output unit 168, a communication unit 170, and/or any other suitable component. Processor 160 includes, for example, a multi-core processor (CMP), a multiprocessor, a central processing unit (CPU), a digital signal processor (DSP), a microprocessor, a host processor, a controller, a plurality of processors or controllers, a chip, a microchip, circuitry, a logic unit, an integrated circuit (IC), an application-specific IC (ASIC), or any other suitable multi-purpose or specific processor or controller. Memory 162 includes, for example, for example, a random access memory (RAM), a dynamic RAM (DRAM), a synchronous DRAM (SD-RAM), a flash memory, a volatile memory, or other suitable memory unit. Storage unit 164 includes, for example, a hard disk drive, a floppy disk drive, a compact disk (CD) drive, a CD-ROM drive, a digital versatile disk (DVD) drive, or other suitable removable or non-removable storage units. Input unit 166 includes, for example, a keyboard, a keypad, a mouse, a touch-pad, a stylus, a microphone, or other suitable pointing device or input device. Output unit 168 includes, for example, a cathode ray tube (CRT) monitor or display unit, a liquid crystal display (LCD) monitor or display unit, a screen, a monitor, or other suitable image and/or video display or output device. Communication unit 170 includes, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data over communication network 108. Communication unit 170 may optionally include, or may optionally be associated with, for example, one or more antennas, e.g., a dipole antenna, a monopole antenna, an omni-directional antenna, an end fed antenna, a circularly polarized antenna, a micro-strip antenna, a diversity antenna, or the like.

In some embodiments, computing devices 112, 114, 122, 124 and/or 132 may include, or may be, a Personal Computer (PC); a desktop computer; a mobile computer; a laptop computer; a notebook computer; a tablet computer; a handheld computer; a handheld device; a Personal Digital Assistant (PDA) device; a handheld PDA device; an on-board device; an off-board device; a hybrid device; a vehicular device; a non-vehicular device; a mobile or portable device; a non-mobile or non-portable device; a wireless communication station; a wireless communication device; a unit or device of a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), a two-way radio communication system, and/or a cellular radio-telephone communication system; a cellular telephone; a wireless telephone; a Personal Communication Systems (PCS) device; a PDA device which incorporates a wireless communication device; a device which incorporates a GPS receiver or transceiver or chip; a Multiple Input Multiple Output (IMO) device; a Single Input Multiple Output (SIMO) device, a Multiple Input Single Output (MISO) transceiver or device; a multi-standard radio device, a wired or wireless handheld device (e.g., BlackBerry, Palm Treo), a Wireless Application Protocol (WAP) device, or the like.

In some embodiments, system 100 may be adapted to enable users of computing devices 112, 114, 122, 124 and/or 132 to share one or more files while ensuring the confidentiality of the shared files, e.g., as described below.

In some embodiments, one or more of computing devices 112, 114, 122, 124 and/or 132 may include, may be associated with, or may perform the functionality of a client application 140 capable of authenticating a user of computing devices 112, 114, 122, 124 and/or 132, respectively; protecting one or more files according to one or more permissions and/or restrictions defined by the user; opening one or more protected files identifying the user as an allowed user; and/or updating the permissions and/or restrictions of the protected files owned by the user, as described in detail below.

In some embodiments, server 102 may include, may be associated with, or may perform the functionality of a server application 104 capable of allowing the user of one or more of computing devices 112, 114, 122, 124 and/or 132 to perform online, via a web browser application 152, one or more of the operations of authenticating the user; protecting one or more files according to one or more permissions and/or restrictions defined by the user; opening one or more protected files identifying the user as an allowed user; and/or updating the permissions and/or restrictions of the protected files owned by the user, as described in detail below.

In some embodiments, server 102 may be implemented using a single server. In other embodiments, server 102 may be implemented using a plurality of servers, e.g., a server “cloud”, which may be located at a single location or at two or more different locations.

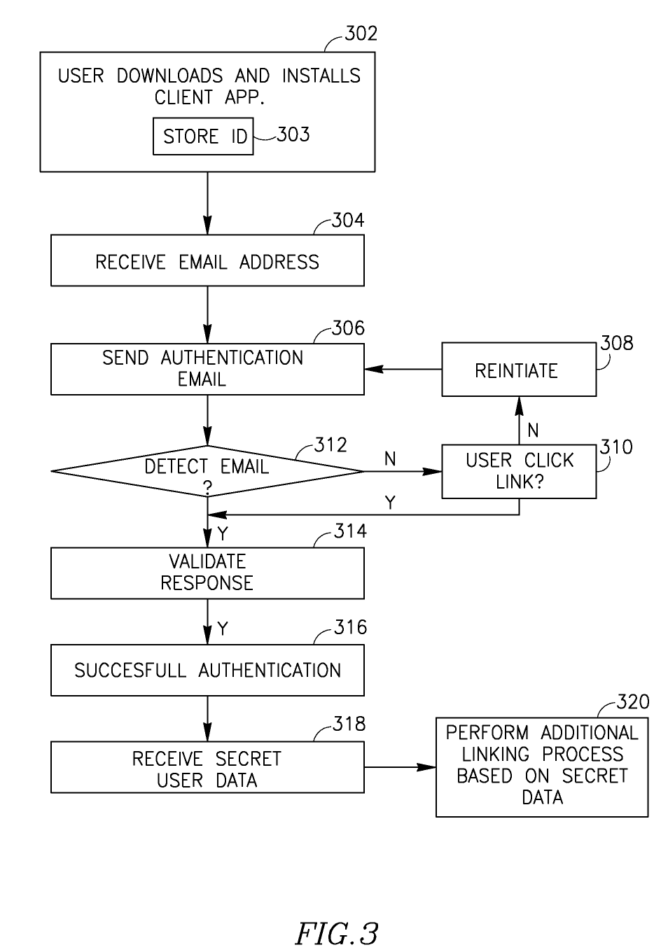

In some embodiments, client application 140 may result from processor 160 executing instructions transferred from server 102 to computing device 112 via communication network 108, e.g., as described below with reference to FIG. 3. In one embodiment, byte-code including the functionality of client application 140 may be downloaded by computing device 112 from server 102, e.g., via communication network 108. In other embodiments, the byte-code may be provided to device 112 in any other suitable manner.

In some embodiments, one or more of computing devices 112, 114, 122, 124 and/or 132 may include, may be associated with, or may perform the functionality of any suitable web browser application 152, e.g., the Windows Internet Explorer, and the like; any suitable one or more user applications 156, e.g., any suitable Microsoft Office application, and the like; and/or any suitable electronic-mail (email) application 157, e.g., the Microsoft Outlook application, and the like.

In some embodiments, client application 140 may provide the user of device 112 with a suitable interface 141, e.g., a Graphical User Interface (GUI), for receiving instructions from the user of device 112 and/or for providing information to the user of device 112, e.g., as described below.

In some embodiments, server application 104 may provide the user of device 112 with a suitable web interface 151, e.g., using browser 152, for receiving instructions from the user of device 112 and/or for providing information to the user of device 112, e.g., as described below.

In some embodiments, client application 140 may associate an add-in module 143 with user application 156 and/or mail application 157. Add-in module 143 may be capable of monitoring and/or controlling the operation of applications 156 and/or 157, e.g., to restrict the utilization of content presented by applications 156 and/or 157 according to instructions received from client application 140; and/or to communicate information between client application 140 and applications 156 and/or 157, e.g., as described below.

In some embodiments, a user of devices 112, 114, 122, 124 and/or 132 may “own” at least one file (“the owned file”), in the sense that the “file owner” may be allowed to define and/or manage one or more restrictions relating to the utilization of the content of the owned file, e.g., as described below. The file owner may include, for example, a user generating the file, an administrator, a user defined by the file owner as an additional owner, and the like.

In some embodiments, server application 104 and/or client application 140 may allow the file owner to protect the owned file, for example, by defining one or more permissions identifying who can and/or who cannot gain access to the protected file; and/or to define one or more utilization-restrictions to be selectively applied on one or more of the users which are allowed to access the protected file (“the allowed users”), e.g., as described in detail below. For example, the file owner may define that a first allowed user may not be permitted to perform any of copy-pasting the content of the protected file, performing a print screen operation of an image representing the content of the protected file, printing the content of the protected file, editing the content of the protected file, and/or any other form of utilizing the protected file, while a second allowed user may be permitted to perform one or more of these operations.

In some embodiments, additionally or alternatively, server application 104 and/or client application 140 may allow the file owner to track substantially all digital copies of the protected file and/or receive information regarding access of other users to the protected file, such as, who opened the protected file and when, who printed the content of the protected file and when, who edited the content of the protected file and when, and the like, e.g., as described in detail below.

In some embodiments, additionally or alternatively, server application 104 and/or client application 140 may allow the file owner to remotely access substantially all digital copies of the protected file, in order, for example, to update the permissions and/or restrictions, e.g., including complete access revocation, e.g., as described in detail below.

In some embodiments, server application 104 and/or client application 140 may identify a user of system 100 based on an email address associated with the user, e.g., as described in detail below.

In some embodiments, permission to access the protected file and/or utilization-restrictions on utilizing the content of the protected file may be defined with respect to email addresses associated with the allowed users. For example, the protected file may be associated with permission information identifying a set of one or more allowed email addresses, e.g., corresponding to the allowed users, and including one or more content-utilization restrictions corresponding to the allowed email addresses, e.g., as described below.

In some embodiments, the permission information may include a set of one or more allowed entities identifying the set of allowed email addresses.

In one embodiment, the permission information may include an allowed entity in the form of a single email address. In another embodiment, the permission information may include an allowed entity in the form of a group or list of email addresses granting access to a group of users that was predefined by the file owner.

In another embodiment, the permission information may include an allowed entity in the form of an Internet domain, thereby to grant access to users of the domain, such that anyone whose email address belongs to a specific domain may have access to the file. For example, if the permission information identifies the domain abc.com, then even if an email address bob@abc.com is not listed directly and/or explicitly by the permission information, the user associated with the email address bob@abc.com may still have access to the file under the utilization restrictions corresponding to the domain. According to this embodiment, a portion of the user's email address is implemented in order to grant the user with access to the protected file.

In yet another embodiment, the permission information may include an allowed entity (“everyone”) in the form of an indication (“everyone indication”) indicating that the allowed electronic mail addresses include all email addresses verified by server application 104 and/or client application 140. In certain situations it may be desirable to grant access to the protected file to any user who has been verified by server application 104 and/or client application 140 since, for example, user actions may be tracked and control is maintained so that permissions may be updated in the future, e.g., as described below.

In some embodiments, the utilization restrictions may include, for example, a utilization restriction relating to each allowed entity. For example, for each allowed email, allowed domain, or the “everyone indicator”, the file owner may decide whether it should be granted access (“white listed”) or denied access (“black listed”).

In some embodiments, server application 104 and/or client application 140 may be capable of linking between a computing device of computing devices 112, 114, 122, 124 and/or 132 (“the linked device”) and at least one email address (“the linked email address”), which may be associated with a user of the computing device, e.g., as described in detail below.

In one embodiment, server application 104 and/or client application 140 may link between computing device 112 and at least one email address associated with a user of device 112, for example, by performing an initial user verification and/or authentication process including verifying that the user of device 112 is authorized to access an electronic mail account represented by the linked email address, e.g., as described in detail below with reference to FIGS. 3 and/or 4.

Some conventional protection systems may implement a login process requiring the user to perform a login operation prior to accessing the protected file. For example, when using the login operation, the user may be allowed to access a protected file based on the knowledge of predefined login information assigned to user of the conventional protection system, e.g., in the form of a username and/or password.

In some embodiments, the linking between the computing device and the email address may enable automatically allowing the user of the linked device to access a protected file, for example, if the linked email address is included in the set of allowed email addresses associated with the protected file. Accordingly, the linking between the computing device and the email address may enable automatically allowing the user of the linked device to access a protected file without, for example, requiring the user of the device to perform a login and/or authentication process, e.g., except for the initial process of linking between the device and the email address. Therefore, the linking between the computing device and the email address may allow the user to access the protected file in a relatively simple, efficient, quick and/or user-friendly manner compared, for example, to the conventional systems requiring the login process.

Additionally, the user may have the possibility of passing on the login information of the conventional system to one or more other, e.g., unauthorized users, in any simple manner, e.g., by phone, conversation, email, chat, and the like. For example, the user may discuss the protected file with another, e.g., unauthorized, user and, as part of the discussion, the user may offer to the other user to view the content of the protected file. The user may then, for example, send the protected file to the other user, e.g., via email, and provide to the other user the login information for accessing the protected file.

In contrast to this aspect of the conventional systems, the linking between the computing device and the email address, according to some embodiments, may not allow a user of a computing device to access the protected file, if the user cannot allow the linking between the computing device and an email associated with the user. Therefore, a first user may attempt to access the protected file, while impersonating, as a second user, only if the first user has access to the email account of the second user. It is assumed that the user of the conventional protection systems may not be very devoted to keeping the login information of the protection system secret compared, for example, to keeping information relating to the email account of the user. Accordingly, the linking between the computing device and the email address may provide an enhanced degree of protection compared, for example, to the conventional systems.

In some embodiments, computing devices 112, 114, 122, 124 and/or 132 may install client application 140, and may use the installed client application 140 to verify one or more email addresses, protect one or more files, and/or to access one or more protected files (“the client application service mode”), e.g., as described below. The installing of client application 140 may allow the users of computing devices 112, 114, 122, 124 and/or 132 to protect a file and/or to access a protected file even during an offline mode of communication, e.g., when not being in communication with server 102.

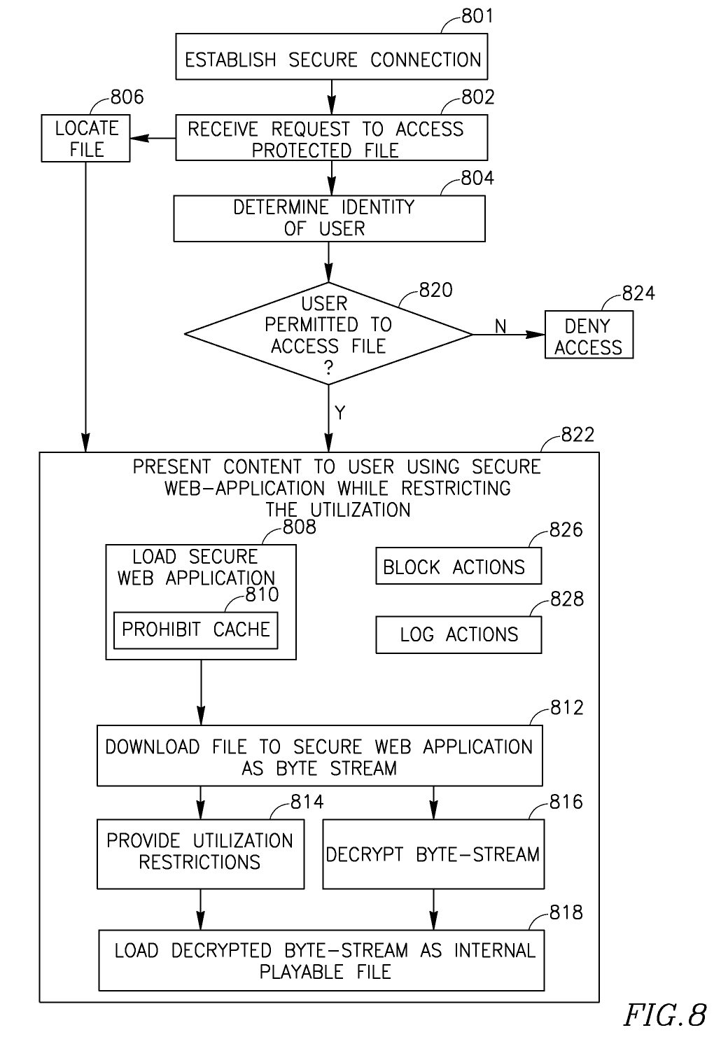

In some embodiments, server application 104 may be capable of allowing the users of computing devices 112, 114, 122, 124 and/or 132 to verify one or more email addresses, protect one or more files, and/or to access one or more protected files using web interface 151 (“the web application service mode”) and without, for example, needing to install client application 140. For example, server application 104 may be capable of linking computing device 132 to an email associated with a user of computing device 132; and/or allowing the user of computing device 132 to protect one or more files. Server application 104 may be capable of generating a web-application file 159 including the content of the file in a format presentable by a secure viewer web application 154 capable of securely managing the utilization of the content according to the content-utilization restrictions, e.g., as described below with reference to FIG. 8. Server application 104 may also selectively present to the user of device 132 the contents of the protected file, e.g., via secure web application 154, while restricting the utilizing of the presented content according to a content-utilization restriction of the protected file corresponding to the email address linked to device 132, as described below.

In some embodiments, server application 104 may store, e.g., in any suitable storage 106, the information of the linked email addresses 144; identifiers (ID) 158 to identify the computing devices linked to the email addresses; public keys 153 assigned to the linked email addresses; public domain keys 155 assigned to the one or more domain entities; and/or general public and keys 157, e.g., as described in detail below. Identifier 158 may include, for example, a unique tag 163 assigned to the linked device, e.g., if the linking of the device is performed at the web-application service mode; and/or a unique identifier assigned to client application 140 of the linked device, e.g., if the linking of the device is performed at the client-application service mode.

In some embodiments, server application 104 may be adapted to determine whether or not identification information, e.g., tag 163, received from a computing device, e.g., computing device 112, actually belongs to the computing device. For example, malware running on a first computing device may potentially obtain the tag 163, e.g., including the web and/or Flash cookie as described below, assigned to the computing device; and provide the tag to a second computing device, which may use the tag to identify the second computing device as being the first computing device. In some embodiments server application 104 may apply any suitable predefined tag validation criteria to validate the received tag, e.g., as described below.

In one example, server application 104 may maintain a predefined number, denoted x1, of Internet-Protocol (IP) addresses previously used by computing device 112. Server application 104 may determine that the received tag is valid if, for example, a current IP address, from which the tag was received, is included in the previous IP addresses.

Additionally or alternatively, server application 104 may maintain a predefined number, denoted x2, of user agents previously used by computing device 112. Server application 104 may determine that the received tag is valid if, for example, a current user agent, from which the tag was received, is included in the previous user agents.

Additionally or alternatively, server application 104 may maintain a predefined number, denoted x3, of browser languages previously used by browser 152. Server application 104 may determine that the received tag is valid if, for example, a current browser language, used for sending the received tag, is included in the previous browser languages.

Additionally or alternatively, server application 104 may maintain a predefined number, denoted x4, of previous settings of one or more IP geographical (geo) profiles of computing device 112. The IP geo profiles may be based on IP geo information, which may include information about the whereabouts of the user of the IP address, for example, the country, region, city, and/or Internet service provider. A first IP geo profile may include, for example, the user's country; a second profile may include a combination of the user's country and city; a third geo profile may include a combination of all geo location parameters, and so on. Server application 104 may determine that the received tag is valid if, for example, a current IP geo profile setting of a communication including the received tag, matches at least one of the previous IP geo profile settings.

Additionally or alternatively, server application 104 may maintain a predefined number, denoted x5, of IP owners of IP addresses previously used by browser 152. Server application 104 may determine that the received tag is valid if, for example, a current IP owner of the IP address used for sending the received tag, is included in the previous IP owners.

In some embodiments, server application 104 may determine whether or not the received tag is valid based, for example, on a set of two or more tag validation criterions, e.g., two or more of the five criterions described above. For example, server application 104 may determine that the received tag is not valid if, for example, at least a predefined number of the set of criterions are not satisfied. In one embodiment, if the tag provided by the computing device is not valid, server application 104 may identify the user based on the secret user information as described below. In another embodiment, if the tag provided by the computing device is not valid, server application 104 reinitiate the authentication process to re-authenticate the computing device.

In some embodiments, server application 104 and/or client application 140 may be adapted to provide the file owner with substantially full control of rights granted to users on each protected file, e.g. regardless of how many copies exist for the protected file and where they are stored. For example, the file owner my have previously decided to grant the users of twenty email addresses and two full Internet domains with access to the protected file. The file owner may decide to revoke access to one or more or even all of these users and domains.

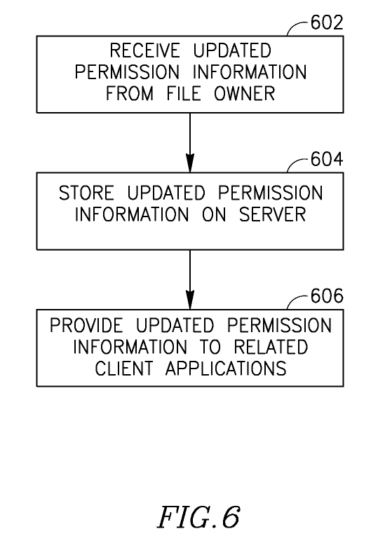

In some embodiments, server application 104 may be capable of receiving an instruction from the file owner including updated permission information relating to the protected file; server application 104 may store the update permission information, e.g., by the updating permission information associated with the web-application protected file 159; server application 104 may update one or more client applications 140 related to the protected file with the updated permission information 197, which may be stored by the client applications 140, e.g., in database 142; and the client applications 140 and server application 104 may then manage the utilization of the protected file according to the updated permission information, e.g., as described below with reference to FIG. 6.

In some embodiments, server application 104 and/or client application 140 may be adapted to provide the file owner of the protected file and/or the administrator with “tracking” and/or “logging” capabilities to track user actions, e.g., file open, print, edit, copy, and the like, with relation to the protected file. For example, such capabilities may be provided via two suitable supporting web applications. A first web application may be tailored for end users, and allowing the end users to track the owned files. A second web application may be tailored for company administrators, to allow the administrators to control all the files owned by users that they administer.

In some embodiments, when a user performs a tracked action with relation to a protected file, add-in 143 may identify the tracked action, e.g., by identifying the sequence of events of operations, as described herein. Add-in 143 may report the detected action to client application 140, which may report the detected action back to server application 104. Server application 104 may maintain the report of the detected action as part of a log 199 in storage 106, and may later query it according to users' or administrators' needs.

In some embodiments, if the user is offline at the time of the action, the detected action may be locally logged as part of database 142. When the user becomes online again, client application 140 may check for unreported actions, and transfer them to server application 104.

In one embodiment, Alice may use computing device 112. Alice may install client application 140, which may link between an email address, alice@(abc.com, belonging to Alice, and computing device 112. Alice may then choose to protect a Microsoft Word file by determining the following access rights: the email address bob@abc.com has access rights and can edit or print the file content, but may not copy the content outside of the file; and the email address charlie@xyz.com has access rights but cannot edit, print or copy the content of the file. Alice may send the file to Bob and Charlie, e.g., via an email message. The email message may include the protected file, wherein the content of the file is encrypted. The protected file may only be opened using client application 140. The email message may also include a link to a copy of the protected file, which may be stored by server 102, e.g., in the form of a web-application file including the content of the file in a format presentable by a web application capable of managing the utilization of the content according to the content-utilization restrictions.

Bob may use device 114. Bob may install client application 140, which may link between the email address bob@(abc.com, belonging to Bob, and computing device 114. Bob may attempt to open the protected file. The installed client application 140 may use add-in 143 to control the Microsoft Word Application to open the protected file, while restricting the Microsoft Word Application to allow Bob to print, edit, and/or save the contents of the file; while not allowing Bob to copy-paste content outside the file, use the Print Screen operation, or perform any other action that extracts the file content. Client application 140 may also allow Bob to open any other protected file that he is allowed to open, e.g., based on the permission information associated with the protected file, by simply double-clicking the file, and the file will open using the applicable native user application 156.

Charlie may use device 132. Charlie may also receive the email message with the protected file, but may select to view the contents of the protected file online, e.g., without installing client application 140 on device 132. Charlie may use the link in the email message. If this is the first time Charlie uses system 100, server application 104 may link between computing device 132 and the email charlie@xyz.com. After linking between device 132 and Charlie's email address, application server 104 may present the web-application file via Charlie's web browser 152, while restricting the utilizing of the content of the protected file according to the permissions corresponding to the email address charlie@xyz.com. For example, server 104 may allow Charlie to view the file but may not allow Charlie to print, edit, or copy the content of the file. Server application 104 may now allow Charlie to access any other protected file that he is allowed to open, e.g., based on the permission information associated with the protected file.

Alice may use a web application to view that both Bob and Charlie opened the file, and when. Two months later Alice may decide to revoke Bob's and Charlie's access to the file. Alice may use either client application 140 or a web application to instruct server application 104 that Bob's and Charlie's access to the file are to be revoked. Server application 104 may be updated immediately, and may also send an update, e.g., in the form of updated permission information 197, to Bob's client application 140. The next time Bob or Charlie try to open the protected file their access is denied.

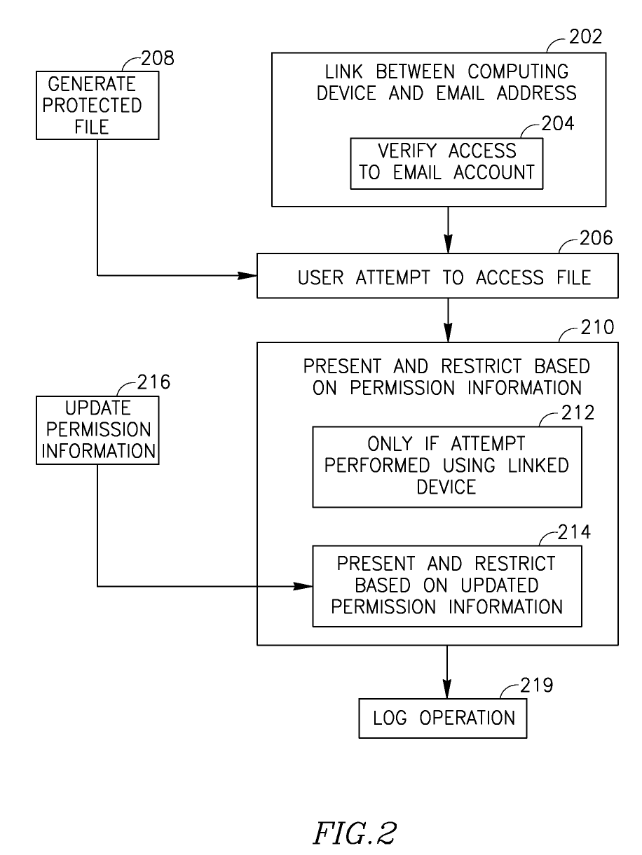

Reference is made to FIG. 2, which schematically illustrates a method of file-utilization management in accordance with some demonstrative embodiments. In some embodiments, one or more operations of the method of FIG. 2 may be performed by one or more elements of system 100 (FIG. 1), e.g., server application 104 (FIG. 1), client application 140 (FIG. 1), and/or computing devices 112, 114, 122, 124 and/or 132 (FIG. 1), for example, to protect a file and/or to manage the utilization of the protected file according to the client application service mode and/or the web application service mode being implemented.

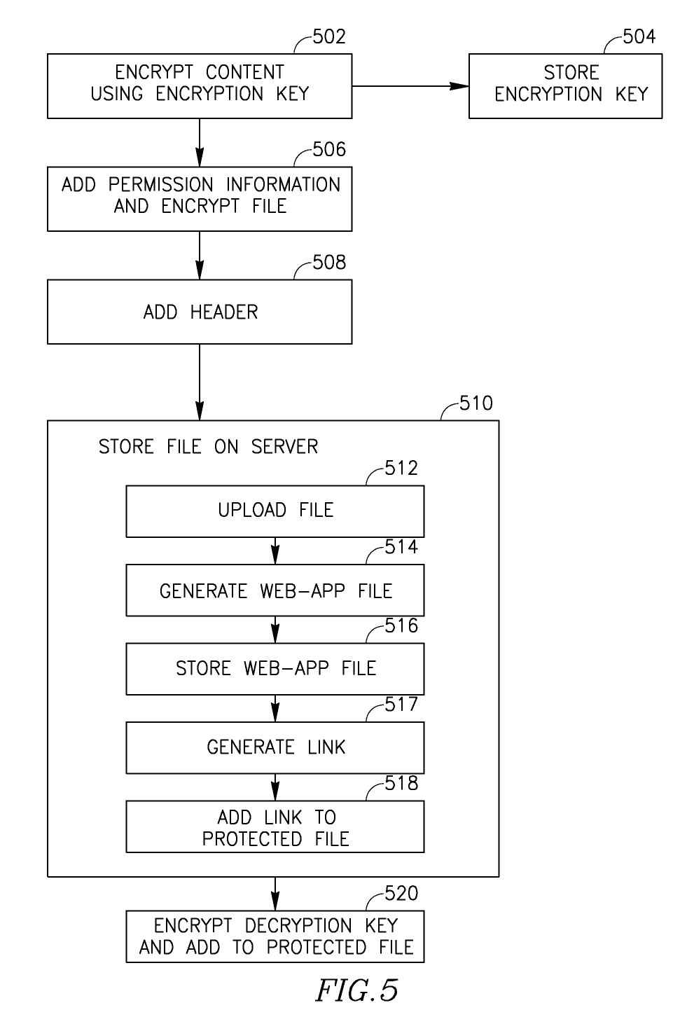

As indicated at block 208, the method may include protecting a file to generate a protected file, e.g., as described below with reference to FIG. 5.

In one embodiment, if the client application service mode is implemented, client application 140 (FIG. 1) may generate the protected file, for example, based on permission information defined by a user of computing device 112 (FIG. 1).

In another embodiment, if the web application service mode is implemented, server application 104 (FIG. 1) may generate the protected file, for example, based on permission information defined by a user of computing device 112 (FIG. 1).

The protected file may be associated with permission information identifying a set of one or more allowed email addresses and including one or more content-utilization restrictions, e.g., as described herein.

In some embodiments, client application 140 (FIG. 1) may receive, e.g., via interface 141 (FIG. 1), an instruction from the user of computing device 112 (FIG. 1) to protect a requested file.

In one embodiment, as part of working on a file using user application 156 (FIG. 1) the user may use interface 141 (FIG. 1) to provide client application 140 (FIG. 1) with an instruction to protect the file according to a certain protection policy. The policy may define the list of allowed entities that should have (“white list”) or should not have (“Black list”) access to the file and one or more utilization restrictions corresponding to the allowed entities. The policy may include a preset policy set in advance by the user or an administrator, or an ad-hoc policy set by the user per the file. For example, the user of device 112 (FIG. 1), when working on the Microsoft Word application, may decide to protect a WORD file with the following policy: the owner of the file is alice@abc.com (the user herself), and bob@abc.com has access but is not allowed to edit or print the content of the WORD file.

In another embodiment, when preparing an email message for sending, e.g., using mail application 157 (FIG. 1), the user of device 112 (FIG. 1) may use interface 141 (FIG. 1) to provide client application 140 (FIG. 1) with an instruction to protect the file according to a certain protection policy. The policy may define the list of allowed entities that should have (“white list”) or should not have (“Black list”) access to the file and one or more utilization restrictions corresponding to the allowed entities. The policy may include a preset policy set in advance by the user or an administrator, or an ad-hoc policy set by the user per the file. For example, the user of device 112 (FIG. 1), when using Microsoft Outlook to send a WORD file as part of an email message, may decide to protect a WORD file with the following policy: all the recipients of the email have access to the attached file but are not allowed to edit or print the content of the file.

In some embodiments, the method may include providing access to the protected file only to a user of a computing device linked to a verified email address, e.g., as described below.

As indicated at block 202, the method may include linking between a computing device and at least one email address.

As indicated at block 204, in some embodiments linking between the computing device and the email address may include verifying that a user of the linked device is authorized to access an email account represented by the linked email address.

In one embodiment, at the client application service mode, the linking may be performed by client application 140 (FIG. 1) to link between a computing device having installed client application 140 (FIG. 1) and an email address associated with the user of the computing device, e.g., as described below with reference to FIG. 3.

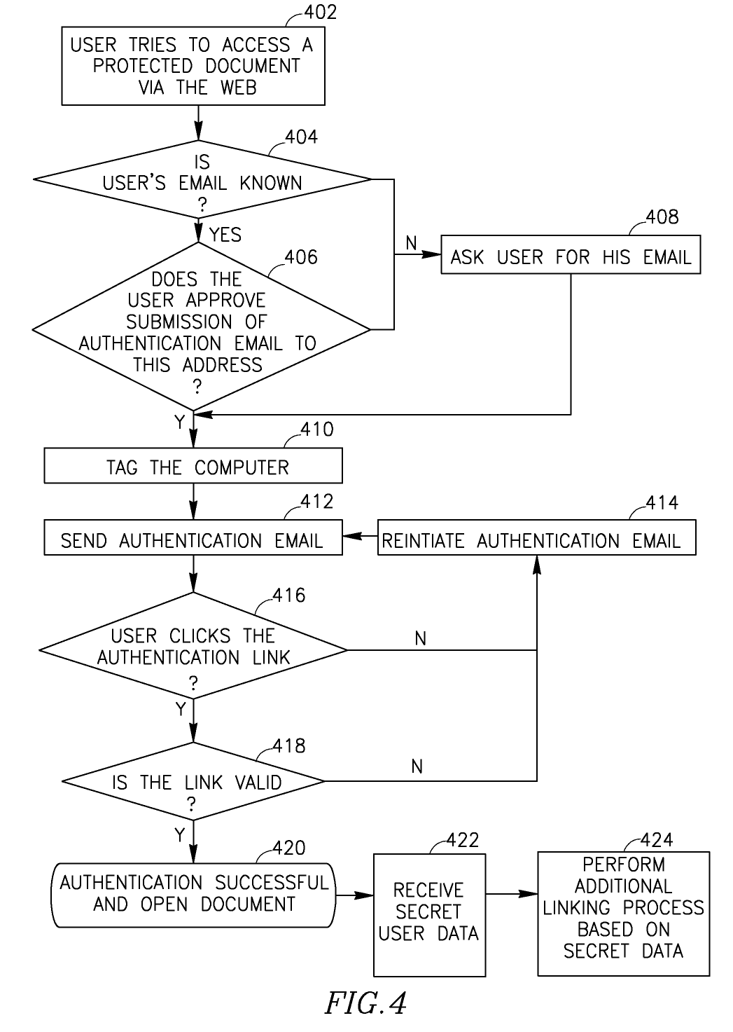

In another embodiment, at the web application service mode, the linking may be performed by server application 104 (FIG. 1), for example, if the linked device does not have client application 140 (FIG. 1) installed, e.g., as described below with reference to FIG. 4.

In some embodiments, server application 104 (FIG. 1) and/or client application 140 (FIG. 1), e.g., when installed by devices 112, 114, 122, 124 and/or 132 (FIG. 1), may be capable of linking between computing device 112 (FIG. 1) and at least one email address by verifying that the user of device 112 (FIG. 1) is authorized to access an email account represented by the email address to device 112 (FIG. 1); linking between computing device 114 (FIG. 1) and at least one email address by verifying that the user of device 114 (FIG. 1) is authorized to access an email account represented by the email address to device 114 (FIG. 1); linking between computing device 122 (FIG. 1) and at least one email address by verifying that the user of device 122 (FIG. 1) is authorized to access an email account represented by the email address to device 122 (FIG. 1); linking between computing device 124 (FIG. 1) and at least one email address by verifying that the user of device 124 (FIG. 1) is authorized to access an email account represented by the email address to device 124 (FIG. 1); and/or linking between computing device 132 (FIG. 1) and at least one email address by verifying that the user of device 132 (FIG. 1) is authorized to access an email account represented by the email address to device 132 (FIG. 1).

As indicated at block 206, the method may include identifying an attempt by the user to access the content of a protected file.

In one embodiment, a the client application service mode, client application 140 (FIG. 1) may receive an indication, e.g., from add-in module 143 (FIG. 1), that the user of device 112 (FIG. 1) is attempting to access the protected file, e.g., using user application 156 (FIG. 1).

In another embodiment, at the web application service mode, server application 104 (FIG. 1) may receive an indication, e.g., in the form of a link to the protected file as described below, that the user of device 112 (FIG. 1) is attempting to access the protected file using the link.

As indicated at block 210, the method may include presenting the content of the protected file to the user of the linked device, if the linked email address is included in the set of allowed email addresses, while restricting the utilizing of the presented content according to a content-utilization restriction corresponding to the linked email address.

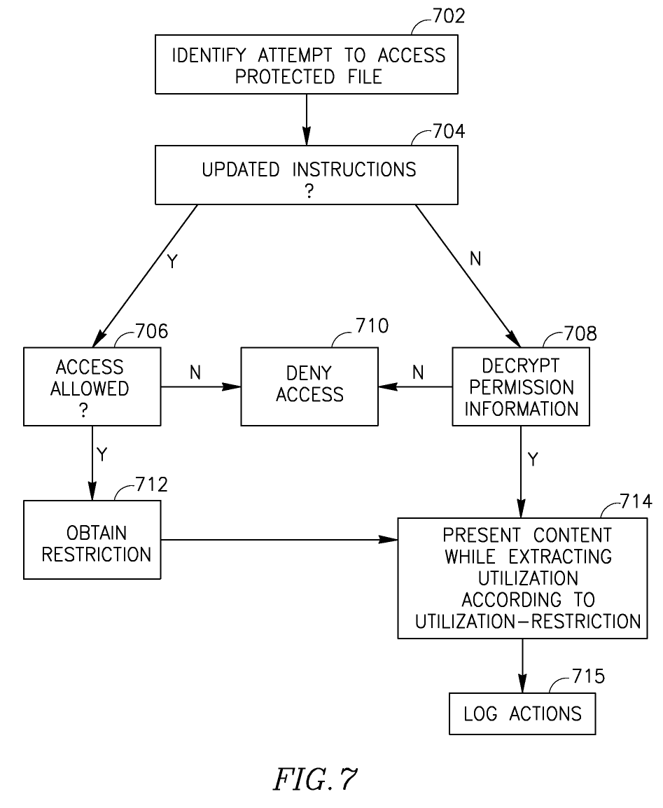

In one embodiment, at the client application service mode, for example, if the computing device has client application 140 (FIG. 1) installed, the presenting of the content of the file may be managed by client application 140 (FIG. 1) e.g., as described below with reference to FIG. 7.

In another embodiment, at the web application service mode, for example, if the computing device does not have client application 140 (FIG. 1) installed, the presenting of the content of the file may be managed by server application 104 (FIG. 1), e.g., via secure web application 154 (FIG. 1) as described below with reference to FIG. 8.

As indicated at block 212, in some embodiments presenting the content of the file may include presenting the content to the user of the computing device, only if the attempt to access the content of the protected file is performed using the linked device, e.g., as described herein.

As indicated at block 216, the method may include updating the permission information associated with the protected file.

In one embodiment, at the client application service mode, client application 140 (FIG. 1) may be provided with the updated permission information, and may transfer the updated permission information to server application 104 (FIG. 1), which in turn may provide the updated permission information to client applications of one or more other computing devices, e.g., as described below with reference to FIG. 6.

In another embodiment, at the web application service mode, the user may directly provide the updated permission, via web application 152 (FIG. 1), information to server application 104 (FIG. 1), which in turn may provide the updated permission information to client applications of one or more other computing devices, e.g., as described below with reference to FIG. 6.

As indicated at block 214, presenting the content of the file may include presenting the content of the file based on the updated permission information, while restricting the utilizing of the presented content according to the content-utilization restriction of the updated permission information, e.g., as described below with reference to FIG. 6.

As indicated at block 219, the method may also include logging one or more actions, e.g., print, edit and/or copy actions, performed by the user with relation to the protected file. For example, client application 140 (FIG. 1) and/or secure application 154 (FIG. 1) may report the one or more actions to server application 104 (FIG. 1), and server application 104 (FIG. 1) may store information regarding the reported actions in log 199 (FIG. 1), and/or provide the information to the file owner of file 159 (FIG. 1).

Reference is made to FIG. 3, which schematically illustrates a method of linking between a computing device and an email address, in accordance with one demonstrative embodiment. One or more operations of the method of FIG. 3 may be performed as part of the client application service mode, for example, by a client application, e.g., client application 140 (FIG. 1), and/or a server application, e.g., server application 104 (FIG. 1), to link between a computing device having installed the client application, e.g., computing device 112 (FIG. 1), and an email address associated with a user of the computing device.

As indicated at block 302, the method may include downloading and installing the client application. For example, device 112 (FIG. 1) may download and install the code of client application 140 (FIG. 1) from server 102 (FIG. 1), and register add-in 143. As indicated at block 303, the method may include storing the ID of the client application. For example, client application 140 (FIG. 1) may generate a unique, unchangeable, client ID 149, which may be internally stored by client application 140 (FIG. 1) as part of an internal, encrypted, database (DB) 142 (FIG. 1). Client ID 149 (FIG. 1) may be used to uniquely identify computing device 112 (FIG. 1).

As indicated at block 304, the method may include receiving at least one email address associated with the user of the computing device. For example, client application 140 (FIG. 1) may automatically approach mail application 157 (FIG. 1) to obtain the at least one email address associated with the user of device 112 (FIG. 1). In one example, email application 157 (FIG. 1) may include the Microsoft Outlook application, and client application 140 (FIG. 1) may obtain the definition of “my email address” from the registry for exchange and/or pop3. In other embodiments, client application 140 (FIG. 1) may receive the email address in any other manner, e.g., automatically or manually from the user.

As indicated at block 306, the method may include informing the server of the email address, and sending an authentication email from the server of the at least one email address (“the authentication request”). For example, client application 140 (FIG. 1) may notify server application 104 (FIG. 1) regarding the email addresses. Client application 140 (FIG. 1) may also provide client ID 149 (FIG. 1) to server 104 (FIG. 1), which may store client ID 149 (FIG. 1) as ID 158 to uniquely identify computing device 112 (FIG. 1). In response, server application 104 (FIG. 1) may send an authentication email message to each of the email addresses, and may notify client application 140 (FIG. 1) that the email messages have been sent. The authentication email message may include authentication information (“first authentication information”), e.g., in the form of a link to the server.

As indicated at block 312, the method may include detecting the authentication email message at the email account.

In some embodiments, the method may include automatically detecting the authentication email message from the server at the electronic mail account. For example, client application 140 (FIG. 1) may control add-in 143 (FIG. 1) to repeatedly search during a predefined time period, e.g., a few seconds, for the email message in the one or more detected email accounts, e.g., in various different folders, such as the “inbox” folder, the “junk email” folder, and the like. Client application 140 (FIG. 1) may also control add-in 143 to initiate the send/receive functionality of mail application 157 so that incoming email messages will arrive instantly.

In some embodiments, the method may include automatically sending to the server a response based on the authentication information. For example, upon recognizing an email message having a predefined format corresponding to the format of the authentication email, add-in 143 (FIG. 1) may provide the authentication information, e.g., the authentication link, included in the authentication message to client application 140 (FIG. 1). Add-in 143 may also delete the authentication email from the email account. Client application 140 (FIG. 1) may automatically send server application 104 (FIG. 1) a response based on the authentication information.

As indicated at block 314, the method may also include verifying the email address based on a validity of the response. For example, server application 104 (FIG. 1) may verify the email address by applying any suitable predefined validation criteria to the information of the response (“second authentication information”).

In some embodiments, server application 104 (FIG. 1) may determine whether the second authentication information matches the first authentication information, and determine that the response is valid, e.g., only if the second authentication information matches the first authentication information.

Additionally or alternatively, server application 104 (FIG. 1) may determine whether the response was received more than a predefined time period after the electronic mail message was sent, and determine that the response is valid, e.g., only if the response was received within the predefined time period.

Additionally or alternatively, server application 104 (FIG. 1) may determine whether a previously received response included the first authentication information and determine that the response is valid, e.g., only if the first authentication information was not included in a previous response.

Additionally or alternatively, server application 104 (FIG. 1) may determine an origin of the response, and determine that the response is valid, e.g., only if the response was received from the same device to which the authentication message was sent. In one example, client application 140 (FIG. 1) may include client ID 149 (FIG. 1) in the authentication request, and server application 104 (FIG. 1) may compare the client ID of the authentication request to the client ID of the response. In another example, application 104 (FIG. 1) may compare the IP address of the authentication request with the IP address of the response.

Additionally or alternatively, server application 104 (FIG. 1) may determine whether the response was sent from one or more predefined IP addresses, and to determine that the response is valid, e.g., only if the response was sent from the predefined IP addresses. The predefined IP addresses may include, for example, IP addresses defined by an administrator.

As indicated at block 316, the method may include verifying that the user is authorized to access the email account, e.g., the response is determined to be valid. For example, server application 104 (FIG. 1) may provide a verification notification to client application 140 (FIG. 1) verifying that the user is authorized to access the email account, if the response is determined to be valid.

In some embodiments, server application 104 (FIG. 1) may generate and provide a private key 146 (FIG. 1), a domain private key 148 (FIG. 1) and a generic private key 150 (FIG. 1) to client application 140 (FIG. 1). Client application 140 (FIG. 1) may internally store private key 146 (FIG. 1), domain private key 148 (FIG. 1) and generic private key 150 (FIG. 1) in database 142 (FIG. 1). Client application 140 (FIG. 1) may also store information representing the linked email 144 (FIG. 1) in database 142 (FIG. 1). Server application 104 (FIG. 1) may store linked email 144 (FIG. 1), public key 153 (FIG. 1) corresponding to private key 146 (FIG. 1), and/or domain public key 155 (FIG. 1) corresponding to domain private key 148 (FIG. 1).

In some embodiments, client application 140 (FIG. 1) may notify the user of device 112, e.g., via interface 141 (FIG. 1), that the verification has been completed.

As indicated at block 310, the method may include manually providing the response to the server, e.g., if the authentication email message is not detected. For example, if add-in 143 (FIG. 1) is not able to automatically detect the authentication email message, then client application 140 (FIG. 1) may notify the user, e.g., via interface 141 (FIG. 1), that in order to complete the authentication process he/she needs to go to the incoming email folders, e.g., the “inbox” folder, of the email address to be verified, locate the authentication message and click the authentication link.

As indicated at block 308, the method may include reinitiating the verification with respect to another email address, e.g., if the authentication message is not detected and/or if the response is determined to be not valid. For example, client application 140 (FIG. 1) may use interface 141 (FIG. 1) to prompt the user to provide another email for verification.

In some embodiments, once the user is authenticated to have access to the linked email address the user may be allowed to use the linked computing device to access protected files indicating the linked email address as an allowed email address. However, from time to time the user may want to link between one or more additional computing devices and/or additional email addresses.

In some embodiments, the method may include linking between the additional computing devices and/or additional email addresses based on additional information received from the user, for example, in order to further strengthen the verification process, e.g., as described below.

As indicated at block 318, the method may include receiving from the user secret user information, e.g., at the end of the initial verification process, or at any point in time thereafter. The secret user information may include, for example, one or more secret questions and answers that only the user is assumed to know. For example, server application 104 (FIG. 1) may receive the secret user information via interface 141 (FIG. 1), e.g., if client application 140 (FIG. 1) is installed; or via web interface 151 (FIG. 1), e.g., if client application 140 (FIG. 1) is not installed.

As indicated at block 320, the method may also include performing an additional linking between the linked device and an additional email address, between an additional device and the linked email address, and/or between an additional device and an additional email address, using the secret user information.

In some embodiments, during a subsequent linking process, server application 104 (FIG. 1) may present the one or more secret questions to the user, and perform the linking only if the user provides the correct answers. If the user cannot provide the right answer, then the user may be instructed to contact an administrator, which may be able to supply an alternative, temporary “shared secret”. Using the secret user information to authenticate the user may provide a strong two-factor authentication process for authenticating the user, since the user is required for something the user knows, e.g., the answer to the secret question, as well as something the user has, e.g., access to the email account.

In some embodiments, the secret information may be used as an alternative for the verification that the user has access to the email address. For example, based on the email address that the user wishes to authenticate, server application 104 (FIG. 1) may present the proper secret question. If the user supplies the right answer the authentication process is deemed successful. This process, while somewhat less secure, may have advantages in terms of usability.

In some embodiments, additional security measures may be implemented to increase the security level of the linking between a computing device and an email address. Such security measures may be implemented by the user and/or an administrator using, for example, suitable web applications.

In one embodiment, a user may be allowed to cancel and/or prohibit the linking of a computing device belonging to the user. Additionally or alternatively, the administrator may be allowed for each user under his/her administration, to cancel and/or prohibit the linking of a computing device belonging to the users.

In another embodiment, the administrator may receive reports and/or alerts for potential authentication breaches. For example, an alert may be generated if a user was authenticated from an IP address that is not within the company's “white list”; a user was authenticated in more than a predefined configurable number of computing device; multiple uses were attempted on a single authentication link; and the like.

Reference is made to FIG. 4, which schematically illustrates a method of linking between a computing device and an email address, in accordance with another demonstrative embodiment. One or more operations of the method of FIG. 4 may be performed as part of the web application service mode, for example, by a server application, e.g., server application 104 (FIG. 1), to link between a computing device, e.g., computing device 112 (FIG. 1), and an email address associated with a user of the computing device.

In some embodiments, one or more operations of the method of FIG. 4 may be implemented to assign and store on the computing device a unique identifier identifying the computing device; and to link between the identifier and the email address associated with the user of the computing device.

One or more operations of the method of FIG. 4 may be implemented to allow the user to access protected files using the linked computing device without, for example, requiring the user perform a login process, e.g., using a password or any alternative authentication mechanism.

As indicated at block 402, the method may include identifying an attempt by the user to access a protected file. For example, the user may attempt to access the protected file via the web, e.g., by clicking on a link to a protected file. For example, server application 104 (FIG. 1) may identify the attempt of the user to access the linked web-application file 159 (FIG. 1), and may initiate a linking process to link the computing device, e.g., if the computing device has not been previously linked with an email address, e.g., if the computing device does not include tag 163 (FIG. 1).

As indicated at block 404, the method may include recognizing one or more email addresses associated with the protected file. For example, server application 104 (FIG. 1) may determine if web-application file 159 (FIG. 1) is associated, in addition to an email address of the file owner of the protected file, with a single email address or multiple email addresses.

As indicated at block 406, if web-application file 159 (FIG. 1) is associated with a single email address other than the email address if the file owner, then server application 104 (FIG. 1) may request, e.g., using web interface 151 (FIG. 1), permission from the user to send an authentication email to the recognized email address. The user may decide to replace the recognized email address with another email address to be linked to the computing device.

As indicated at block 408, the method may include requesting an email address from the user. For example, server application 104 (FIG. 1) may ask the user for the email address to be linked to the computing device, e.g., if server application 104 (FIG. 1) cannot associate an email address with the user and/or if the user does not approve submission of authentication email to the suggested email address.

As indicated at block 410, the method may include assigning a tag identifying the linked device in association with the linked electronic mail address. For example, server application 104 (FIG. 1) may provide computing device 112 (FIG. 1) with tag 163 (FIG. 1) uniquely identifying computing device 112 (FIG. 1). Server application 104 (FIG. 1) may store ID 158 (FIG. 1) corresponding to tag 163 (FIG. 1).

Providing the tag to the linked device may include providing the linked computing device with a cookie message including the tag.

In one embodiment, the cookie message may include a web cookie including the tag 163 (FIG. 1). Server application 104 (FIG. 1) may receive the web cookie including tag 163 (FIG. 1), e.g., whenever the user browses web application 152 (FIG. 1).

In another embodiment, the cookie may include a Flash cookie. For example, web application 152 (FIG. 1) may use a very small, e.g., one pixel, Flash movie, which may be unnoticed by the user. The flash movie may enable storing the Flash cookie on the computing device, e.g., assuming that the computing device has the Flash application installed.

As indicated at block 412, the method may include sending an authentication email message from the server to the approved email address (“the authentication request”). For example, server application 104 (FIG. 1) may send an authentication email message to the approved email address. The authentication email message may include authentication information (“first authentication information”), e.g., in the form of a link to the server. Server application 104 (FIG. 1) may also inform the user, e.g., via interface 151 (FIG. 1) that in order to complete the authentication process, the user is to go to the inbox of the email address, locate the authentication email and click the authentication link.

As indicated at block 416, the method includes detecting a received response including second authentication information. For example, the user may click the authentication link.

As indicated at block 418, the method may also include verifying the email address based on a validity of the response. For example, server application 104 (FIG. 1) may verify the email address by applying any suitable predefined validation criteria to the information of the response (“second authentication information”), e.g., including one or more of the criteria described above with reference to block 314 (FIG. 1).

In some embodiments, server application 104 (FIG. 1) may determine an origin of the response, and determine that the response is valid, e.g., only if the response was received from the same device to which the authentication message was sent. For example, server application 104 (FIG. 1) may determine if one of tags 163 (FIG. 1) maintained by computing device 112 (FIG. 1) is identical to the tag assigned by server application 104 (FIG. 1). In another example, server application 104 (FIG. 1) may compare the IP address of the authentication request with the IP address of the response.

As indicated at block 420, the method may include verifying that the user is authorized to access the email account, e.g., the response is determined to be valid. For example, server application 104 (FIG. 1) may provide a verification notification to the user, e.g., via interface 151 (FIG. 1), verifying that the user is authorized to access the email account. In addition, server application 104 (FIG. 1) may present the content of the protected file to the user, e.g., via secure web application 154 (FIG. 1), as described herein.

As indicated at block 414, the method may include reinitiating the verification with respect to another email address, e.g., if the response is not detected and/or if the response is determined to be not valid. For example, server application 104 (FIG. 1) may use web interface 151 (FIG. 1) to prompt the user to provide another email for verification.

In some embodiments, once the user is authenticated to have access to the linked email address the user may be allowed to use the linked computing device to access protected files indicating the linked email address as an allowed email address. However, from time to time the user may want to link between one or more additional computing devices and/or additional email addresses.

In some embodiments, the method may include linking between the additional computing devices and/or additional email addresses based on additional information received from the user, for example, in order to further strengthen the verification process, e.g., as described below.

As indicated at block 422, the method may include receiving from the user secret user information, e.g., as described above with reference to block 318 (FIG. 3).

As indicated at block 424, the method may also include performing an additional linking between the linked device and an additional email address, between an additional device and the linked email address, and/or between an additional device and an additional email address, using the secret user information, e.g., as described above with reference to block 320 (FIG. 3).

In some embodiments, additional security measures may be implemented increase the security level of the linking between the computing device and the email address, e.g., as described above with reference to FIG. 3.

Reference is made to FIG. 5, which schematically illustrates a method of protecting a file, in accordance with some demonstrative embodiments. One or more operations of the method of FIG. 5 may be performed as part of the client application service mode and/or as part of the web application service mode, for example, by a client application, e.g., client application 140 (FIG. 1), and/or a server application, e.g., server application 104 (FIG. 1), to protect a file by a user of a computing device, e.g., computing device 112 (FIG. 1).

As indicated at block 502, the method may include encrypting the file using an encryption key to generate a protected file including the encrypted file. In one embodiment, in the client application service mode, add-in 143 (FIG. 1) may generate the encryption key, e.g., a one-time symmetric key, and encrypt the content of the file using the encryption key. In another embodiment, in the web application service mode, server application 104 (FIG. 1) may generate the encryption key, and encrypt the content of the file using the encryption key.

As indicated at block 504, the method may also include storing the encryption key. For example, client application 140 (FIG. 1) may encrypt the encryption key, e.g., using general key 150 (FIG. 1) and transfer the encryption key to server application 104 (FIG. 1), which may store encryption key 194 (FIG. 1).

As indicated at block 506, the method may include adding to the protected file the permission information corresponding to the file, as defined by the user. For example, the permission information, defining the one or more allowed entities identifying one or more allowed emails and one or more utilization-restrictions, may be added to the protected file, which may then be re-encrypted using the encryption key.

As indicated at block 508, the method may include adding a header portion, e.g., an unencrypted header, to the protected file, e.g., at the beginning of the protected file. The header may provide an unencrypted message to users who are trying to open the protected file without using the right application. For example: for Microsoft Office files, an unencrypted HTML header may be added. In some embodiments, the header portion may also include a link to a web-application file corresponding to the protected file, e.g., as described below with reference to block 510.

As indicated at block 520, the method may include generating one or more encrypted keys corresponding to one or more allowed electronic mail addresses, respectively, by encrypting the encryption key using one or more predefined keys associated with the allowed entities. The encrypted decryption keys may be added to the protected file.

In one embodiment, the allowed entity may include one or more email addresses, e.g., as described above. Accordingly, the decryption keys may include one or more public keys 153 (FIG. 1) corresponding to the email addresses.

In another embodiment, the allowed entities may include at least one Internet domain, e.g., as described above. Accordingly, the decryption keys may include the domain public key 155 (FIG. 1) corresponding to the domain.

In another embodiment, the allowed entities may include the “everyone” entity, as described above. Accordingly, the decryption keys may include general public key 157 (FIG. 1).

In some embodiments, the protection of the file may be performed by server application 104 (FIG. 1), e.g., at the web application service mode. Accordingly, server application 104 (FIG. 1) may retrieve the required decryption keys from storage 106 (FIG. 1).

In another embodiment, the protection of the file may be performed by client application 140 (FIG. 1), e.g., at the client application service mode. Client application 140 (FIG. 1) may request the decryption keys from server application 104 (FIG. 1). Client application 140 (FIG. 1) may maintain, for example, a cache of public keys previously received by client application 140 (FIG. 1), such that client application 140 (FIG. 1) may reuse the public keys in the future, e.g., even when working offline.

In some embodiments, if client application 140 (FIG. 1) performs the protection of the file when device 112 (FIG. 1) is working offline, then client application 140 (FIG. 1) may encrypt the file using general public key 150 (FIG. 1), and transfer the encrypted file to server application 104 (FIG. 1), e.g., when device 112 (FIG. 1) goes online. Sever application 4 (FIG. 1) may then decrypt the file, and protect the contents of the file, e.g., as described above.

As indicated at block 510, in some embodiments the method may include storing the file on the server, e.g., as described below. For example, server application 104 (FIG. 1) may store a copy of the file, e.g., in order to provide web access to the protected file at the web application service mode. Server application 104 (FIG. 1) may store the copy of the protected file, for example, as part of the process of generating the protected file, e.g., during either the client application service mode and/or the web application service mode.

As indicated at block 512, the method may include uploading the content of the file, for example, if the file is being protected by client application 140 (FIG. 1). For example, client application 140 (FIG. 1) may generate a copy of the file and transfer the copy to server application 104 (FIG. 1), e.g., via a client-server secure connection.

As indicated at block 514, the method may include generating a web-application file including the content of the protected file in a format presentable by a web application capable of managing the utilization of the content according to the content-utilization restrictions. For example, server application 104 (FIG. 1) may convert the received file into a suitable Flash (swf) file in a format presentable by secure application 154 (FIG. 1), which in turn may be capable of managing the utilization of the content according to the content-utilization restrictions, e.g., as described below with reference to FIG. 8.

As indicated at block 516, the method may also include storing the web-application file. For example, server application 104 (FIG. 1) may store web-application file 159 (FIG. 1) including the content of the protected file. The method may also include storing an identifier of the protected web-application file in association with the permission information corresponding to the protected web-application file. For example, server application 104 (FIG. 1) may store a file ID 198 (FIG. 1) in association with the permission information 189 (FIG. 1) corresponding to web-application file 159 (FIG. 1).

As indicated at block 517, the method may include generating a link including the identifier of the protected file. For example, server application 104 (FIG. 1) may generate a link to web-application file 159 (FIG. 1) including file ID 198 (FIG. 1).

As indicated at block 518, the method may include adding the link to the protected file. In one example, e.g., if the file is being protected at the web application service mode, server application 104 (FIG. 1) may embed the link as part of the protected file, e.g., as part of the header of the protected file and/or as part of the email including the protected file. In another example, e.g., if the file is being protected at the client application service mode, server application 104 (FIG. 1) may provide the link to client application 140 (FIG. 1), which may embed the link as part of the protected file, e.g., as part of the header of the protected file and/or as part of the email including the protected file.

In some embodiments, generating the web-application file may include encrypting the content using a file key; and generating the link may include generating the link including the file key. The file key may be destroyed and not stored by server application 104 (FIG. 1) and/or client application 140 (FIG. 1). Accordingly, there may be no way to decrypt the web-application file 159 (FIG. 1), for example, until receiving the link identifying web-application file 159 (FIG. 1) as part of a process of opening the protected file using the web-application service mode, e.g., as described below with reference to FIG. 8.

One or more operations of FIG. 5 may be implemented to protect a file using the web-application service mode. For example, the user may upload the file to server application 102 (FIG. 1), while using interface 151 (FIG. 1) to determine the permission information corresponding to the file. The user may then submit the protected file to one or more recipients, e.g., via email, in a suitable format implemented by mail application 157 (FIG. 1). The sent email may include the protected file including the embedded link to web-application file 159 (FIG. 1), and/or a direct link to web-application file 159 (FIG. 1).

Reference is made to FIG. 6, which schematically illustrates a method of updating permission information corresponding to a protected file, in accordance with some demonstrative embodiments. One or more operations of the method of FIG. 6 may be performed as part of the client application service mode and/or as part of the web application service mode, for example, by a client application, e.g., client application 140 (FIG. 1), and/or a server application, e.g., server application 104 (FIG. 1), to update permission information corresponding to a protected file.

As indicated at block 602, the method may include receiving updated permission information from the file owner. For example, the user of device 112 (FIG. 1) may decide to change or revoke permissions associated with a previously protected file. In one example, the user may user the web application service mode to provide server application 104 (FIG. 1) with the updated permission information, e.g., using web interface 151 (FIG. 1). In another example, if the client application service mode is used, add-in 143 (FIG. 1) may detect the change in the permissions, which may be provided to client application 140 (FIG. 1), which in turn may provide the updated permission information to server 104 (FIG. 1). If the user of device 112 (FIG. 1) is offline at the time of the permission change, client application 140 (FIG. 1) may maintain a log of the change in database 142 (FIG. 1). When the user becomes online again, client application 140 (FIG. 1) may check for unreported permission changes, and transfer these changes to server application 104 (FIG. 1).

As indicated at block 604, the method may include storing the updated permission information in the server. For example, sever application 104 (FIG. 1) may update the permission information 189 (FIG. 1) corresponding to the protected web application file 159 (FIG. 1), which corresponds to the protected file, to reflect the updated permission information received from the file owner. Accordingly, from this point onwards, server application 104 (FIG. 1) may apply the updated permission information with regards to any attempt to access web application 159 (FIG. 1).

As indicated at block 606, the method may include providing the updated permission information to one or more client applications related to the protected file. For example, server application 104 (FIG. 1) may provide updated permission information 197 (FIG. 1) to each client application 140 (FIG. 1) relevant to the change in the permission information, for example, to each client application corresponding to a revoked email address, an added email address, and/or an email address corresponding to an updated utilization restriction. Each application client 140 (FIG. 1) may store the received updated permission information 197 (FIG. 1), e.g., in database 142 (FIG. 1).

In some embodiments, server application 104 (FIG. 1) may maintain an open communication channel with all online client applications 140 (FIG. 1), e.g., in order to enable sever application 102 (FIG. 1) to update client applications 140 (FIG. 1). If a client application 140 is offline, server application 104 (FIG. 1) may deliver the updated permission information to the client application, e.g., as soon as the client application becomes online.

In some embodiments, server application 104 (FIG. 1) may update all client applications 140 of the computing devices linked to the same email address, e.g., if the same email address of the user is linked with several computing devices.

In some embodiments, the updated permission information may include permission to a newly added user. Accordingly, server application 104 (FIG. 1) may encrypt encryption key 194 (FIG. 1) corresponding to the protected file, e.g., using public key 153 (FIG. 1) corresponding to the client application 140 (FIG. 1) of the new user; and provide the encrypted key to the client 140 (FIG. 1) of the new user together with the updated permission information 197 (FIG. 1).

In some embodiments, if the updated permission information relates to an Internet domain (“the updated domain”), then there may be a need to potentially update all client applications 140 (FIG. 1) related to the domain. If the updated permission information relates to the “everyone” entity, there may be a need to potentially update a relatively large number of client applications 140 (FIG. 1), e.g., potentially all the client applications in system 100 (FIG. 1).

In some embodiments, if the updated domain is relatively small, e.g., if the domain includes less than a predefined configurable number of verified users, then server application 104 (FIG. 1) may update all the client applications related to the updated domain, e.g., as described above.

In some embodiments, one or more of the operations described below may be performed when a verified user accesses a protected file under the domain/everyone permission, for example, if the updated domain is relatively large, e.g., the updated domain includes more than the predefined number of verified users and/or if the updated permission information relates to the “everyone” entity.

If the user is online, client application 140 (FIG. 1) may check with server application 104 (FIG. 1), e.g., in real time, whether or not the permissions for the domain/everyone have been updated. If the user is offline the access to the file is allowed based on the permission information included in the protected file. Additionally, server application 104 (FIG. 1) may add the user to a list of users, which are to be provided with immediate updates whenever the permission information corresponding to the protected file is updated with respect to the domain/everyone. This mechanism may ensure that even when permissions to whole domains or to “everyone” are changed or revoked, the relevant users will be affected instantly while keeping the effect on communication and storage at a minimal level.

Reference is now made to FIG. 7, which schematically illustrates a method of managing the utilization of a protected file, in accordance with one demonstrative embodiment. One or more operations of the method of FIG. 7 may be performed as part of the client application service mode, for example, by a client application, e.g., client application 140 (FIG. 1), to present the content of a protected file to a user of a linked computing device, e.g., computing device 112 (FIG. 1), which has been previously linked to a verified email address.

As indicated at block 702, the method may include identifying an attempt to access the protected file. For example, add-in 143 (FIG. 1) may identify an attempt to open a file, e.g., via hooks on the Windows Application Program Interface (API), and determine if the file is a protected file.

As indicated at block 704, the method may include checking for updated permission instructions. For example, client application 140 (FIG. 1) may check for updated permission information 197 (FIG. 1) corresponding to the protected file.

As indicated at block 706, the method may include determining whether or not the user is permitted to access the protected file based on the updated permission information, e.g., if the updated permission information is detected.

As indicated at block 712, the method may include obtaining from the updated permission information the utilization-restrictions corresponding to the user, e.g., if it is determined that the user is permitted to access the protected file. For example, if the most updated instruction is that the user email address, the domain associated with the user email address, or the “everyone” entity should have access, then client application 140 (FIG. 1) may obtain the utilization-restriction from updated permission information 197 (FIG. 1).

In some embodiments, if the updated permission information includes the permission to the user as a newly added user, e.g. if the user had no permission to access the protected file prior to the update, then client application 140 (FIG. 1) may use private key 146 (FIG. 1) to decrypt the encrypted encryption key 194 (FIG. 1), which may be included together with updated permission information 197 (FIG. 1) as described above; and use encryption key 194 (FIG. 1) to encrypt the content of the protected file.

In some embodiments, if there is a collision between restrictions, e.g. user and domain access both apply with different restrictions, the more specific definitions may be applied.

As indicated at block 708, the method may include decrypting the permission information included in the protected file. For example, client application 140 (FIG. 1) may attempt to decrypt the permission information of the protected file, e.g., using any private keys 146 (FIG. 1), domain key 148 (FIG. 1) and/or general key 150 (FIG. 1). Upon decrypting the permission information, client application 140 (FIG. 1) may obtain from the permission information the utilization-restrictions corresponding to the user, e.g., as described above.

As indicated at block 710, the method may include denying access to the protected file, e.g., if the access is not allowed according to the updated permission information and/or if the attempt to decrypt the permission information of the protected file fails. For example, client application 140 (FIG. 1) may notify the user that access to the protected file is denied, e.g., using the interface 141 (FIG. 1).

As indicated at block 714, the method may include presenting the content of the protected file to the user, while restricting the utilizing of the presented content according to the content-utilization restriction corresponding to the user. For example, add-in 143 (FIG. 1) may enforce the content-utilization restriction by identifying and blocking the sequence of events of certain operations, e.g., using suitable application-specific APIs, Win32 API hooks, and the like.

As indicated at block 715, the method may include logging one or more actions of the user with respect to the protected file. The one or more logged actions may include, for example, opening the file, editing the contents of the file, printing the contents of the file, using the “print screen” function, and the like. For example, add-in 143 (FIG. 1) may identify the tracked action, and report the detected action to client application 140 (FIG. 1), which may report the detected action back to server application 104 (FIG. 1). Server application 104 (FIG. 1) may maintain the report of the detected action as part of log 199 (FIG. 1). If the user is offline at the time of the action, the detected action may be locally logged as part of database 142 (FIG. 1). When the user becomes online again, client application 140 (FIG. 1) may check for unreported actions, and transfer them to server application 104 (FIG. 1).

Reference is now made to FIG. 8, which schematically illustrates a method of managing the utilization of a protected file, in accordance with another demonstrative embodiment. One or more operations of the method of FIG. 8 may be performed as part of the web application service mode, for example, by a server application, e.g., server application 104 (FIG. 1), to present the content of a protected file to a user of a linked computing device, e.g., computing device 112 (FIG. 1), which has been previously linked to a verified email address.

In some embodiments, one or more operations of the method of FIG. 8 may be performed to allow one or more users of system 100 (FIG. 1), e.g., the user of device 112 (FIG. 1), having a web browser, e.g., browser 152 (FIG. 1), and an application, e.g., the Flash application, capable of playing the internal playable file, to access web-application file 159 (FIG. 1) according to the one or more utilization restrictions, while not requiring the users to download and/or install client application 140 (FIG. 1).

As indicated at block 801, the method may include establishing a secure connection between the server application and a web browser of the linked device. For example, web browser 152 (FIG. 1) may establish a secure connection with server application 104 (FIG. 1), e.g., using the HyperText Transfer Protocol Secure (https) or any other suitable protocol.

As indicated at block 802, the method may include receiving a request to access the protected web-application file. For example, the user of device 112 (FIG. 1) may click the link that leads to web-application file 159 (FIG. 1). As a result server application 104 (FIG. 1) may receive a request including the file ID 198 (FIG. 1) corresponding to the web-application file 159 (FIG. 1) and the file decryption key, as embedded in the link, e.g., as described above.

As indicated at block, 804, the method may include determining the identity of the user. For example, server application 104 (FIG. 1) may retrieve tag 163 (FIG. 1) from computing device 112 (FIG. 1), determine the ID 158 of computing device 112 (FIG. 1) based on the retrieved tag 163 (FIG. 1), and determine the at least one linked email address 144 (FIG. 1) corresponding to ID 158 (FIG. 1).

As indicated at block 806, the method may include locating the protected file, e.g., based on the received request. For example, server application 104 (FIG. 1) may locate protected web-application file 159 (FIG. 1) based on the ID 198 (FIG. 1).

As indicated at block 820, the method may include determining whether or not the user is permitted to access the protected file. For example, server application 104 (FIG. 1) may determine whether or not the user of device 112 (FIG. 1) is permitted to access the protected file by comparing the linked email address 144 (FIG. 1) to the permission information 189 (FIG. 1) corresponding to the received file ID 198 (FIG. 1).

In some embodiments, if there is a collision between restrictions, e.g. user and domain access both apply with different restrictions, the more specific definitions may be applied.

As indicated at block 824, the method may include denying access to the protected file, e.g., if the access is not allowed according to the permission information. For example, sever application 104 (FIG. 1) may notify the user that access to the protected file is denied, e.g., using the interface 151 (FIG. 1).

As indicated at block 822, the method may include presenting the content of the protected file to the user of the linked device, while restricting the utilizing of the presented content according to a content-utilization restriction corresponding to the linked email address, e.g., if it is determined that the user is permitted to access the protected file. For example, in some embodiments server application 104 (FIG. 1) may generate secure web application 154 (FIG. 1) within browser 152 (FIG. 1) to present the content of the protected file while enforcing the utilization restriction corresponding to the user of device 112 (FIG. 1), as described below.

In some embodiments, server application 104 (FIG. 1) may use secure web application 154 (FIG. 1) to present the contents of the protected file to the user of device 112 (FIG. 1), while making sure that the user cannot take the protected file or portions of the content of the protected file elsewhere, e.g., where unauthorized use of the content might be made. For example, secure web application 154 (FIG. 1) may be adapted to ensure that actions like saving the browser page or viewing its source will not enable to copy the content of the protected file.

As indicated at block 826, presenting the contents of the protected file while restricting the utilizing of the presented content according to the content-utilization restriction may include blocking one or more user actions based on the content-utilization restriction. The actions may include, for example, the ability to edit the contents of the file, the ability to print the contents of the file, the ability to copy the contents of the file, the ability to use the “print screen” function, and the like.

As indicated at block 828, presenting the contents of the protected file while restricting the utilizing of the presented content according to the content-utilization restriction may include logging one or more actions of the user. The one or more logged actions may include, for example, opening the file, editing the contents of the file, printing the contents of the file, using the “print screen” function, and the like.

As indicated at block 808, the method may include loading a secure web application viewer to the web browser of the linked device. For example, server application 104 (FIG. 1) may load secure web application 154 (FIG. 1) into web browser 152 (FIG. 1), and may send the file decryption key to secure web application 154 (FIG. 1) via the secure connection.

As indicated at block 812, the method may include downloading a byte stream including the encrypted web-application file to the secure web application, e.g., via the secure connection. For example, server application 104 (FIG. 1) may download, as a byte stream, the encrypted web-application file 159 (FIG. 1) to secure web application 154 (FIG. 1).

As indicated at block 814, the method may include providing the utilization-restriction to the secure web application. For example, server application 104 (FIG. 1) may provide the utilization-restriction to secure web application 154 (FIG. 1) via the secure connection.

As indicated at block 816, the method may include decrypting the byte-stream by the secure web-application using the received file decryption key. For example, secure web application 154 (FIG. 1) may decrypt the byte stream representing web-application file 159 (FIG. 1) using the received decryption file key.

As indicated at block 818, the method may include loading the decrypted byte-stream as an internal playable file, e.g., a Shockwave Flash (swf) file or any other suitable format, inside the secure web application. Accordingly, the protected file may be maintained encrypted outside the secure application.

As indicated at block 810, in some embodiments the method may include prohibiting caching. For example, server application 104 (FIG. 1) may load secure web application 154 (FIG. 1) to browser 152 (FIG. 1) with a suitable instruction, e.g., in the form of an http header, to instruct browser 152 (FIG. 1) not to cache secure web application 154 (FIG. 1), e.g., in a temporary internet file folder.

In some embodiments, the internal playable file, e.g., the swf file, may not exist as a decrypted file, since it is received by secure web application 154 (FIG. 1) as a byte stream which, after decryption, is immediately loaded, e.g., without being cached anywhere.

In some embodiments, the internal playable file may include pages of the protected file as frames, as well as suitable functions, e.g., ActionScript functions, for performing actions on the pages. The functions may include, for example, a “next page” function to switch to a next page, a “previous page” function to switch to a previous page, a “zoom” function, a “search” function, a print function, a “select text” function, a “copy” function, and the like. Secure web application 154 (FIG. 1) may include any suitable GUI control to enable the user to perform the actions on the internal playable file. For example, secure web application 154 (FIG. 1) may include a toolbar including a “select” button, a “print” button, a “copy” button, and the like. The selection and/or activation of an action may call an ActionScript function of the internal playable file.

In some embodiments, secure web application 154 (FIG. 1) may be adapted to selectively enable and/or disable the functions of the internal playable file, in order to selectively allow the user of device 112 (FIG. 1) to perform actions on the internal playable file in accordance with the utilization restriction. For example, secure web application 154 (FIG. 1) disable a “print” button, prohibit text selection, and/or prohibit editing of the internal playable file if, for example, the utilization-restriction prohibits the printing, copying and/or editing of the content of the protected file.

In some embodiments, secure web application 154 (FIG. 1) may be adapted to prevent the presenting of the content of the protected file, even if the user performs one or more functions or commands, e.g., the “print screen” command, which are not fully controllable by secure web application 154 (FIG. 1). For example, secure web application 154 (FIG. 1) may “cover”, “hide” and/or obfuscate the contents of the protected file, for example, if secure web application 154 (FIG. 1) identifies that web browser 152 (FIG. 1) is “out of focus”.

In some embodiments, secure web application 154 (FIG. 1) may report to server application 104 (FIG. 1) one or more of the actions, e.g., the print, edit and/or copy actions, performed by the user with relation to the internal playable file. Server application 104 (FIG. 1) may store information regarding the reported actions in log 199 (FIG. 1), and/or provide the information to the file owner of file 159 (FIG. 1).

In some embodiments, secure web application 154 (FIG. 1) may be adapted to track input operations performed by the user of device 112 (FIG. 1), e.g., via input unit 166 (FIG. 1). For example, secure web application 154 (FIG. 1) may be adapted to track keystrokes and/or mouse clicks performed by the user. Based on the detected input operations, secure web application 154 (FIG. 1) may be adapted to detect user actions performed externally to secure web application 154 (FIG. 1), e.g., the “Print Screen” action. Secure web application 154 (FIG. 1) may also report such actions to server application 104 (FIG. 1), e.g., as described above.

In some embodiments, at least part of secure web application 154 (FIG. 1) may be obfuscated in order for example, to protect at least decryption ActionScript code responsible for the decryption of web application file 159 (FIG. 1).

Server application 104 (FIG. 1) and/or secure web application 154 (FIG. 1) may implement any suitable protections, security, validation, integrity checking, and/or obfuscation methods, mechanisms and/or algorithms, e.g., one or more of the methods described below.

In one embodiment, server application 104 (FIG. 1) and/or secure web application 154 (FIG. 1) may implement a code encryption method. For example, at least part of the code of secure web application 154 (FIG. 1) may be maintained encrypted, and decrypted only when running them.

In another embodiment, server application 104 (FIG. 1) and/or secure web application 154 (FIG. 1) may implement any suitable module authentication methods. For example, secure web application 154 (FIG. 1) may be adapted to use reflection to create a checksum of one or more modules and/or functions, and to include the checksum output as part of the code of secure web application 154 (FIG. 1). When running, secure web application 154 (FIG. 1), may verify the checksum to make sure the code was not manipulated. Additionally or alternatively, secure web application 154 (FIG. 1) may use the checksum of one or more parts of the code in order to open one or more other parts of the code.

In another embodiment, server application 104 (FIG. 1) and/or secure web application 154 (FIG. 1) may implement any suitable module integrity methods. For example, one or more portions of secure web application 154 (FIG. 1) may be hashed, e.g., using any suitable hashing function, and the hash output may be used as a key to encrypt one or more other portions of secure web application 154 (FIG. 1). Accordingly, the encrypted portions may not be opened if, for example, a hashed portion has been manipulated.

In another embodiment, server application 104 (FIG. 1) and/or secure web application 154 (FIG. 1) may implement any suitable module anti-debugging methods, e.g., to ensure that secure web application 154 (FIG. 1) is not running under a debugger. In one example, a Flash API may be used to obtain the anti-debugging methods. In another example, a timing scheme may be used, for example, secure web application 154 (FIG. 1) may benchmark and continuously monitor the performance of secure web application 154 (FIG. 1). When performance times go below a certain threshold, secure web application 154 (FIG. 1) may prohibit any further operation.

In another embodiment, server application 104 (FIG. 1) and/or secure web application 154 (FIG. 1) may implement any suitable code interpretation. For example, an intermediate virtual machine layer may be created between the virtual machine, e.g., the Flash virtual machine, running secure web application 154 (FIG. 1) and between secure web application 154 (FIG. 1). The intermediate layer may interpret the code of secure web application 154 (FIG. 1) to the Flash virtual machine; and, in one or more portions, the intermediate layer may manipulate the code such that an unauthorized user, e.g., a hacker, will not be able to follow the code.

In another embodiment, server application 104 (FIG. 1) and/or secure web application 154 (FIG. 1) may implement any suitable whitebox cryptography method. For example, the file decryption key corresponding to web application file 159 (FIG. 1) may be translated, e.g., by server application 104 (FIG. 1), into a suitable mathematical manipulation. Server application 104 (FIG. 1) may then provide to secure web application 154 (FIG. 1) ActionScript code capable of performing the decryption of web application file 159 (FIG. 1) in run time. Using such method may ensure that the file decryption key is not disclosed outside server 102 (FIG. 1).

In another embodiment, server application 104 (FIG. 1) and/or secure web application 154 (FIG. 1) may implement any suitable online server authentication. For example, secure web application 154 (FIG. 1) may be adapted to authenticate the identity of server 102 (FIG. 1). In one example, secure web application 154 (FIG. 1) may generate a one-time unique number (“blob”), and send the blob to server application 104 (FIG. 1). Server application 104 (FIG. 1) may combine the blob with any predefined value, e.g., may add the blob to a value representing today's date, may encrypt the result using a private key assigned to server 102 (FIG. 1), and may send the encrypted value back to secure web application 154 (FIG. 1). Secure web application 154 (FIG. 1) may use a public key associated with serve 102 (FIG. 1) to decrypt the encrypted value, and to thereby authenticate the identity of server 102 (FIG. 1).

In another embodiment, server application 104 (FIG. 1) and/or secure web application 154 (FIG. 1) may implement any suitable individualization methods, for example, to manipulate the code of secure web application 154 (FIG. 1), such that every time a unique variation of secure web application 154 (FIG. 1) is download to the browser.

As described above, at least some relevant restrictions on file 159 (FIG. 1), e.g., the ability to copy-paste the content of the file, print or edit the document, and the like, may be internally allowed/disabled by secure web application 154 (FIG. 1). In some embodiments, one or more “external” operations which may be performed, for example, by the user of device 112 (FIG. 1) using browser application 152 (FIG. 1) and/or any other external applications, may be selectively allowed disabled based on the utilization restriction, e.g., as described below.

In some embodiments, the printing of the whole HTML file embedding secure web application 154 (FIG. 1) may be restricted, for example, using a suitable html page style definition resulting in the printing of a blank page, e.g., when clicking on the browser print button.

In some embodiments, the “print screen” operation may be restricted. In one example, suitable code, e.g., JavaScript code, may be used to delete the user's clipboard frequently. In another example, a suitable code, e.g., an ActiveX code, may be used to disable the print screen functionality.

Some embodiments are described herein with reference to including the file decryption key of a web-application file as part of the link associated with the web application file, e.g., as described above. However, in other embodiments, the file decryption key corresponding to the web application file may be maintained in any other suitable manner. For example, the file decryption keys corresponding to one or more of web application files 159 (FIG. 1) may be stored by server 102 (FIG. 1). The file decryption keys may be stored, for example, in a separate location from web application files 159 (FIG. 1), e.g., as part of a separate database and/or storage having strict access control measures. According to these embodiments, the link to web application file 159 (FIG. 1) may include the ID of web application file 159 (FIG. 1), while the file decryption key corresponding to web application file 159 (FIG. 1) may be provided be server application 104 (FIG. 1) to secure web application 154 (FIG. 1), which may perform the decryption subsequent to the downloading of web application file 159 (FIG. 1) to secure web application 154 (FIG. 1).

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A method of file-utilization management, the method comprising:
linking between a computing device and at least one electronic mail address by verifying that a user of the linked computing device is authorized to access an electronic mail account represented by the linked electronic mail address;
identifying an attempt by the user to access the content of a protected file, wherein the protected file is associated with permission information representing one or more allowed electronic mail addresses and including one or more content-utilization restrictions; and
presenting the content of the protected file to the user of the linked device, if the linked electronic mail address is included in the allowed electronic mail addresses, while restricting the utilizing of the presented content according to a content-utilization restriction corresponding to the linked electronic mail address.

2. The method of claim 1, wherein the presenting comprises presenting the content to the user, only if the attempt to access the content of the protected file is performed using the linked computing device.

3. The method of claim 1, wherein linking between the electronic mail address and the computing device comprises storing a tag identifying the linked device in association with the linked electronic mail address.

4. The method of claim 3, wherein linking between the electronic mail address and the device comprises providing the linked device with a cookie message including the tag.

5. The method of claim 1, wherein linking between the electronic mail address and the computing device comprises associating the linked electronic mail address and an identifier of a client application executed by the computing device.

6. The method of claim 1, wherein verifying that the user is authorized to access the electronic mail account comprises:
informing a server of the electronic mail address; and
receiving a verification notification from the server, if the user is authorized to access the electronic mail account.

7. The method of claim 6 comprising:
automatically detecting an electronic mail message from the server at the electronic mail account, wherein the message includes authentication information; and
automatically sending to the server a response based on the authentication information.

8. The method of claim 1, wherein verifying that the user is authorized to access the electronic mail account comprises:
sending to the electronic mail address an electronic mail message including first authentication information; and
verifying that the user is authorized to access the electronic mail account based on a received response including second authentication information.

9. The method of claim 8, wherein verifying the electronic mail address based on the response comprises at least one of:
determining whether the second authentication information matches the first authentication information;
determining whether the response was received more than a predefined time period after the electronic mail message was sent;
determining whether a previously received response included the first authentication information;
determining whether the response was sent by the linked computing device; and
determining whether the response was sent from one or more predefined Internet-protocol addresses.

10. The method of claim 1 comprising generating the protected file by:
receiving the content and the permission information; and
generating a web-application file including the content in a format presentable by a secure web application capable of managing the utilization of the content according to the content-utilization restrictions;
wherein presenting the content of the protected file comprises presenting the web-application file via the secure web application.

11. The method of claim 10 comprising:
storing the web-application file;
storing the identifier of the web-application file in association with the permission information corresponding to the web-application file; and
generating a link including an identifier of the web-application file;
wherein identifying the attempt to access the content of the protected file includes receiving the link, and identifying the web-application file based on the identifier.

12. The method of claim 1, wherein the content of the protected file is encrypted using at least a public key associated with the linked electronic mail address, and wherein presenting the content of the protected file includes decrypting the content using a private key corresponding to the public key.

13. The method of claim 1 comprising protecting a requested file based on user-defined permission information identifying one or more requested electronic mail addresses and including one or more utilization restrictions corresponding to the requested electronic mail addresses, wherein protecting the requested file comprises:
encrypting the requested file using an encryption key to generate an encrypted file;
generating one or more encrypted keys corresponding to the one or more requested electronic mail addresses, respectively, by encrypting said encryption key using one or more predefined keys associated with said requested electronic mail addresses; and
generating a requested protected file including the encrypted file, the encrypted keys, and the permission information.

14. The method of claim 13, wherein the predefined keys include at least one of a public key associated with a requested electronic mail address, a domain key associated with an Internet domain, and a general key associated with all verified electronic mail addresses.

15. The method of claim 1 comprising updating the permission information of the protected file,
wherein presenting the content of the protected file comprises presenting the content to the user, only if the linked electronic mail address is included in the allowed electronic mail addresses identified by the updated permission information, and
wherein restricting the utilizing of the presented content comprises restricting the utilizing of the presented content according to a content-utilization restriction included in the updated permission information.

16. The method of claim 1, wherein the permission information identifying the allowed electronic mail addresses includes at least one Internet domain, and wherein presenting the content of the protected file includes presenting the content of the protected file to the user if the linked electronic mail address belongs to the domain.

17. The method of claim 16, wherein the content of the protected file is encrypted using at least a public domain key associated with the domain, and wherein presenting the content of the protected file includes decrypting the content using a private domain key corresponding to the public domain key.

18. The method of claim 1, wherein the permission information identifying the allowed electronic mail addresses indicates that the allowed electronic mail addresses include all verified electronic mail addresses.

19. The method of claim 18, wherein the content of the protected file is encrypted using at least a general public key, and wherein presenting the content of the protected file includes decrypting the content using a generic private key corresponding to the general public key.

20. The method of claim 1 comprising log one or more actions performed by the user with respect to the content.

21. A computing device comprising:
a client application to link between a computing device and at least one electronic mail address by verifying that a user of the linked computing device is authorized to access an electronic mail account represented by the linked electronic mail address; identify an attempt by the user to access the content of a protected file, wherein the protected file is associated with permission information representing one or more allowed electronic mail addresses and including one or more content-utilization restrictions; and present the content of the protected file to the user of the linked device, if the linked electronic mail address is included in the allowed electronic mail addresses, while restricting the utilizing of the presented content according to a content-utilization restriction corresponding to the linked electronic mail address.

22. The apparatus of claim 21, wherein the client application is to link between the electronic mail address and the computing device by storing the linked electronic mail address.

23. The apparatus of claim 21, wherein the client application is to verify that the user is authorized to access the electronic mail account by informing a server of the electronic mail address; and receiving a verification notification from the server, if the user is authorized to access the electronic mail account.

24. The apparatus of claim 23, wherein the client application is to automatically detect an electronic mail message from the server at the electronic mail account, wherein the message includes authentication information; and to automatically send to the server a response based on the authentication information.

25. The apparatus of claim 21, wherein the client application is to protect a requested file based on user-defined permission information identifying one or more requested electronic mail addresses and including one or more utilization restrictions corresponding to the requested electronic mail addresses, and
wherein the client application is to protect the requested file by encrypting the requested file using an encryption key to generate an encrypted file; generating one or more encrypted keys corresponding to the one or more requested electronic mail addresses, respectively, by encrypting said encryption key using one or more predefined keys associated with said requested electronic mail addresses; and generating a requested protected file including the encrypted file, the encrypted keys, and the permission information.

26. The apparatus of claim 25, wherein the predefined keys include at least one of a public key associated with a requested electronic mail address, a domain key associated with an Internet domain, and a general key associated with all verified electronic mail addresses.

27. The apparatus of claim 21, wherein the client application is to receive updated permission information corresponding to the file, and wherein the client application is to present the content to the user, only if the linked electronic mail address is included in the allowed electronic mail addresses identified by the updated permission information, and to restrict the utilizing of the presented content according to a content-utilization restriction included in the updated permission information.

28. The apparatus of claim 21, wherein the permission information identifying the allowed electronic mail addresses includes at least one Internet domain, and wherein the client application is to present the content of the protected file to the user if the linked electronic mail address belongs to the domain.

29. The apparatus of claim 28, wherein the content of the protected file is encrypted using at least a public domain key associated with the domain, and wherein the client application is to decrypt the content using a private domain key corresponding to the public domain key.

30. The apparatus of claim 21, wherein the permission information identifying the allowed electronic mail addresses indicates that the allowed electronic mail addresses include all verified electronic mail addresses.

31. The apparatus of claim 30, wherein the content of the protected file is encrypted using at least a general public key, and wherein the client application is to decrypt the content using a generic private key corresponding to the general public key.

32. An enterprise-digital-rights-management system comprising:
a server to link between a computing device and at least one electronic mail address by verifying that a user of the linked computing device is authorized to access an electronic mail account represented by the linked electronic mail address; to identify an attempt by the user to access the content of a protected file, wherein the protected file is associated with permission information representing one or more allowed electronic mail addresses and including one or more content-utilization restrictions; and to present the content of the protected file to the user of the linked device, if the linked electronic mail address is included in the allowed electronic mail addresses, while restricting the utilizing of the presented content according to a content-utilization restriction corresponding to the linked electronic mail address.

33. The system of claim 32, wherein the server is to present the content to the user, only if the attempt to access the content of the protected file is performed using the linked computing device.

34. The system of claim 32, wherein the server is to store a tag identifying the linked device in association with the linked electronic mail address.

35. The system of claim 34, wherein the server is to provide the linked device with a cookie message including the tag.

36. The system of claim 30, wherein the server is to send to the electronic mail address an electronic mail message including first authentication information; and verify that the user is authorized to access the electronic mail account based on a received response including second authentication information.

37. The system of claim 36, wherein the server is to verify the electronic mail address based on the response by performing at least one of:
determining whether the second authentication information matches the first authentication information;
determining whether the response was received more than a predefined time period after the electronic mail message was sent;
determining whether a previously received response included the first authentication information;
determining whether the response was sent by the linked computing device; and
determining whether the response was sent from one or more predefined Internet-protocol addresses.

38. The system of claim 32, wherein the server is to generate the protected file by receiving the content and the permission information; and generating a web-application file including the content in a format presentable by a secure web application capable of managing the utilization of the content according to the content-utilization restrictions, and
wherein the server is to present the content of the protected file by presenting the web-application file via the secure web application.

39. The system of claim 38, wherein the server is to store the web-application file; store the identifier of the web-application file in association with the permission information corresponding to the web-application file; generate a link including an identifier of the web-application file; receive the link; and identify the web-application file based on the identifier of the link.

40. The system of claim 32, wherein the server is to protect a requested file based on user-defined permission information identifying one or more requested electronic mail addresses and including one or more utilization restrictions corresponding to the requested electronic mail addresses, wherein the server is to protect the requested file by:
encrypting the requested file using an encryption key to generate an encrypted file;
generating one or more encrypted keys corresponding to the one or more requested electronic mail addresses, respectively, by encrypting said encryption key using one or more predefined keys associated with said requested electronic mail addresses; and
generating a requested protected file including the encrypted file, the encrypted keys, and the permission information.

41. The system of claim 40, wherein the predefined keys include at least one of a public key associated with a requested electronic mail address, a domain key associated with an Internet domain, and a general key associated with all verified electronic mail addresses.

42. The system of claim 32, wherein the server is to log one or more actions performed by the user with respect to the content.
